(19) United States
(12) Patent Application Publication
(10) Pub. No.: US 2026/0246903 A1
(43) Pub. Date: Aug. 20, 2026

(54) THREE DIMENSIONAL GENERATIVE PRE-TRAINED TRANSFORMER AND METHODS OF USE

(71) Applicants: Jerry Nims, Sandy Springs, GA (US); William M. Karszes, Hilton Head, SC (US); Samuel Pol, Lawrenceville, GA (US)

(72) Inventors: Jerry Nims, Sandy Springs, GA (US); William M. Karszes, Hilton Head, SC (US); Samuel Pol, Lawrenceville, GA (US)

(21) Appl. No.: 19/545,662

(22) Filed: Feb. 20, 2026

Related U.S. Application Data
(60) Provisional application No. 63/760,748, filed on Feb. 20, 2025.
(60) Provisional application No. 63/872,587, filed on Aug. 29, 2025.

(51) Int. Cl. H04N 13/128; H04N 13/122; H04N 13/275; H04N 13/305; H04N 13/324

(52) U.S. Cl. CPC H04N 13/128; H04N 13/122; H04N 13/275; H04N 13/305; H04N 13/324

(57) ABSTRACT

A three-dimensional (3D) display stack structure and method integrate AI-generated 3D images with secure optical components for anti-counterfeiting and stereoscopic visualization. The structure includes a thin-film transistor (TFT) glass layer with pixel control transistors, a TFT polarizer for light filtering, a color filter (CF) glass layer with RGB sub-pixels, a CF polarizer for light modulation, a Micro Optical Material (MOM) layer featuring lenticular lenses (radius of curvature approximately 0.52) and microstructures such as diffraction gratings for parallax-based 3D effects and security, liquid optically clear adhesive (LOCA) bonding TFT and CF layers, optically clear adhesive (OCA) bonding the MOM to a protective/display layer, and a protective cover enabling stereoscopic viewing. An AI Three Dimensional Generative Pre-trained Transformer (3DGPT), trained on proprietary datasets of paired RGB images and ground truth depth maps including legacy 3D formats and synthetic data, generates high-accuracy monocular depth maps from single 2D RGB images using an encoder-decoder architecture with optimized loss functions invariant to scale and bias. Security features, including micro-text, holograms, UV/IR inks, and encoded data, are embedded in the MOM and 3D images, authenticated offline by a Secure Pattern Recognition smartphone application via high-resolution camera capture and computer vision. The system supports applications in secure documents, currency, medical imaging, augmented reality, and virtual reality with enhanced depth accuracy and counterfeit resistance.

### CROSS REFERENCE TO RELATED APPLICATIONS

To the full extent permitted by law, the present United States Non-Provisional Patent Application claims priority to and the full benefit of, U.S. Application No. 63/760,748 filed on Feb. 20, 2025 entitled “AI Three Dimensional Generative Pre-Trained Transformer and Methods of Use” and U.S. Application No. 63/872,587 filed on Aug. 29, 2025 entitled “AI Three Dimensional Generative Pre-Trained Transformer and Methods of Use”; and is related to U.S. application Ser. No. 19/007,331 filed on Dec. 31, 2024 entitled “SINGLE 2D IMAGE CAPTURE SYSTEM, PROCESSING & DISPLAY OF 3D DIGITAL IMAGE” (10537-RA4CON2CIP3); U.S. application Ser. No. 18/922,152 filed on Oct. 21, 2024 entitled “SINGLE 2D IMAGE CAPTURE SYSTEM, PROCESSING & DISPLAY OF 3D DIGITAL IMAGE” (10537-RA4CON2CIP2); U.S. application Ser. No. 18/790,734 filed on Jul. 31, 2024 entitled “SINGLE 2D IMAGE CAPTURE SYSTEM, PROCESSING & DISPLAY OF 3D DIGITAL IMAGE” (10537-RA4CON2CIP); U.S. application Ser. No. 19/006,527 filed on Dec. 31, 2024 entitled “SINGLE 2D DIGITAL IMAGE CAPTURE SYSTEM, FRAME SPEED, AND SIMULATING 3D DIGITAL IMAGE SEQUENCE” (10537-RA5CIP4); U.S. application Ser. No. 18/927,204 filed on Oct. 25, 2024 entitled “2D DIGITAL IMAGE CAPTURE SYSTEM, FRAME SPEED, AND SIMULATING 3D DIGITAL IMAGE SEQUENCE” (10537-RA5CIP3); U.S. application Ser. No. 18/884,487 filed on Sep. 13, 2024 entitled “2D DIGITAL IMAGE CAPTURE SYSTEM, FRAME SPEED, AND SIMULATING 3D DIGITAL IMAGE SEQUENCE” (10537-RA5CIP2); U.S. application Ser. No. 18/887,980 filed on Sep. 17, 2024 entitled “SUBSURFACE IMAGING AND DISPLAY OF 3D DIGITAL IMAGE AND 3D IMAGE SEQUENCE” (10537-RA10CON). The foregoing is incorporated herein by reference in their entirety.

### FIELD OF THE DISCLOSURE

The present disclosure is directed to conversion of 2D images into 3D depth maps from a single RGB image for use in product packaging security.

### BACKGROUND

Monocular Depth Estimation enables the conversion of 2D images into 3D depth maps from a single RGB image, without the need for multiple cameras or specialized equipment like depth sensors. Current image manipulation tools, such as MIDAS estimate the depth of scenes captured in photographs or videos. By analyzing the visual cues within a single image, they attempt to predict how far or close objects are from the camera's viewpoint, creating a grayscale image where pixel intensity corresponds to depth-brighter areas denote objects closer to the camera, and darker areas indicate objects further away. While these tools provides good results, the accuracy can vary based on the complexity of the scene or the quality of the input image.

A disadvantage with conventional image depth tools the objects in a scene may be incorrectly layered front to back when brightness and darkness levels are incorrectly assigned to objects in a scene resulting in inaccurate 3D image generation from depth maps.

A disadvantage with conventional image depth tools is the objects in a scene may be assigned incorrect key subject, foreground, and background cues creating a grayscale image where pixel intensity incorrectly corresponds to depth.

A disadvantage in the domain of computer vision and artificial intelligence, monocular depth estimation involves inferring 3D depth information from a solitary 2D RGB image, circumventing the need for stereo cameras or depth sensors. Conventional methods often exhibit limitations in accuracy due to insufficient training data, inadequate handling of multi-view disparities, or lack of robust loss functions.

Therefore, it is readily apparent that there is a recognizable unmet need for a Three Dimensional Generative Pre-trained Transformer and methods of use that may be configured to address at least some aspects of the problems discussed above.

### SUMMARY

Briefly described, in an example embodiment, the present disclosure may overcome the above-mentioned disadvantages and may meet the recognized need for a Three Dimensional Generative Pre-trained Transformer and methods of use to provide a secure three-dimensional (3D) imaging system and method utilizing an artificial intelligence (AI) Three Dimensional Generative Pre-trained Transformer (3DGPT) for generating high-accuracy 3D depth maps from single 2D RGB images via monocular depth estimation. The Three Dimensional Generative Pre-trained Transformer trained on proprietary datasets comprising paired RGB images and ground truth depth maps having key subject, foreground, and background, true data points the 3DGPT employs an encoder-decoder neural network with optimized loss functions to produce 3D images integrated with Micro Optical Materials (MOMs) featuring lenticular lenses and microstructures for parallax effects, embedding security features such as micro-text, holograms, lenticular line frequency variations, and encoded data to make replication hard for anti-counterfeiting. The system may also include a display having Micro Optical Materials (MOMs) featuring lenticular lenses and microstructures for parallax effects formed as a multi-layer display stack with thin-film transistor (TFT) and color filter (CF) components bonded by optically clear adhesives. A companion Secure Pattern Recognition (SPR) smartphone application authenticates these features using high-resolution camera capture and computer vision, enabling applications in secure documents, secure labels, tickets, currency, virtual reality, and stereoscopic displays with enhanced visual fidelity and resistance to duplication.

It is an object of the disclosure herein to provide high-accuracy monocular depth estimation from a single 2D RGB image, overcoming limitations of existing tools like MIDAS by correctly assigning brightness and darkness levels to objects, thereby preventing incorrect layering in complex scenes and enabling precise 3D image generation.

It is an object of the disclosure herein to leverage proprietary datasets with ground truth images, legacy 3D formats (e.g., Nimslo, Nidek medical), and synthetic data for training, resulting in robust performance across diverse environments such as security printing, mobile devices, medical imaging, and earth observation.

It is an object of the disclosure herein to enable zero-shot cross-dataset transfer by mixing multiple datasets during training, improving generalization and state-of-the-art results on unseen data, as demonstrated through novel loss functions invariant to depth range, scale, and biases.

It is an object of the disclosure herein to integrate AI-generated 3D images with Micro Optical Materials (MOMs) to create visually complex, tamper-resistant products and packaging that are difficult to counterfeit, enhancing security for applications like documents, tickets, currency, IDs, virtual reality, and stereoscopic displays.

It is an object of the disclosure herein to incorporate multi-layered anti-counterfeiting measures, including micro-text, nano-text, holograms, UV/IR inks, lenticular line frequency variations, and encoded data (e.g., serial numbers, timestamps), which are only verifiable via proprietary decoding, providing superior protection against duplication or forgery.

It is an object of the disclosure herein to support offline functionality in the Secure Pattern Recognition (SPR) smartphone app, ensuring reliable authentication without internet dependency, while optimizing battery efficiency and device compatibility across iOS and Android platforms.

It is an object of the disclosure herein to facilitate real-time image processing and pattern recognition using high-resolution cameras (48 MP+), autofocus, macro modes, and AI/ML models, allowing for quick, accurate detection of intricate patterns under varying lighting conditions.

It is an object of the disclosure herein that employs optimized optical designs in MOMs, such as lenticular lenses with a radius of curvature of approximately 0.52 and refractive index of 1.52, to produce parallax shifts, depth perception, and non-repeating diffraction gratings, enhancing visual fidelity and security integrity.

It is an object of the disclosure herein that utilizes a multi-objective training approach with supervised, regularization, and photometric losses to adapt to scale and bias shifts, leading to improved depth map accuracy and efficiency in large-scale data processing.

It is an object of the disclosure herein to offer a cohesive system for secure 3D imaging and authentication, reducing the need for multiple cameras or specialized depth sensors, thereby lowering costs and simplifying deployment in critical sectors like consumer goods, healthcare, and transportation.

A feature of the present disclosure includes an AI Three Dimensional Generative Pre-trained Transformer (3DGPT) model trained on proprietary datasets comprising paired RGB images and depth maps, featuring distinct elements like Key Subject, Foreground, and Background for accurate 3D reconstruction.

A feature of the present disclosure includes a method for creating the 3DGPT, including steps for data selection (ground truth images), preparation (normalization, augmentation, ETL processes), architecture selection (U-Net or ResNet with attention mechanisms), loss function incorporation, training, evaluation, optimization, and deployment.

A feature of the present disclosure includes a 3D display stack structure comprising: MOM layer with microstructures (e.g., lenticular lenses and diffraction gratings.

A feature of the present disclosure includes a secure interphase/pattern module embedded in the MOM and 3D image, incorporating features like microprinting, holograms, lenticular line frequency, and encoded data visible only under specific conditions, retrievable solely via proprietary methods.

A feature of the present disclosure includes a 3D display stack structure comprising: thin-film transistor (TFT) glass layer for pixel control; TFT polarizer for light filtering; color filter (CF) glass layer with RGB sub-pixels; CF polarizer for light modulation; MOM layer with microstructures (e.g., lenticular lenses and diffraction gratings); liquid optically clear adhesive (LOCA) for bonding TFT and CF layers; optically clear adhesive (OCA) for bonding MOM and protective layers; and a protective/display layer for stereoscopic visualization.

A feature of the present disclosure includes a Secure Pattern Recognition (SPR) mobile application utilizing computer vision to decode and authenticate(ing) Security Features, supporting high-resolution camera capture (at least 48 MP), real-time processing (edge detection, noise reduction, contrast enhancement), AI-driven pattern analysis for QR codes, barcodes, or custom designs, and supports offline functionality.

A feature of the present disclosure includes an incorporation of advanced neural network components, such as multi-scale supervision and reprojection losses for multi-view consistency, ensuring high-fidelity grayscale depth maps suitable for 3D mesh generation, generative infill, and parallax shifting.

A feature of the present disclosure includes optical calculations for MOM design, including acceptance angle (α), radius of curvature (R≈0.52), refractive index (n′=1.52), thickness (t), height (h), width (w), and focal length (f), to manipulate light for enhanced 3D effects and security.

A feature of the present disclosure includes system compatibility with stereoscopic-enabled tablets or digital displays, enabling output of AI-generated 3D images with embedded security patterns for applications in 3D reconstruction, augmented reality, autonomous navigation, visual effects in film, object detection and segmentation, and anti-counterfeit products.

A feature of the present disclosure includes a data pipeline for handling structured and unstructured sources (e.g., databases, APIs, cloud storage), with preprocessing techniques like scaling, cropping, flipping, and color jittering to maintain dataset consistency.

A feature of the present disclosure includes an artificial intelligence system with a processor and memory storing the proprietary dataset, configured to receive a single RGB image, apply an encoder-decoder network to extract depth cues, and output a 3D image with parallax shift and security embeddings.

A feature of the present disclosure includes MOM material Features: selecting a substrate with predetermined optical properties, patterning said substrate with microstructures configured to manipulate light in a unique manner, desired optical effects like diffraction, refraction, or reflection, arranged in a pattern that is non-repeating or pseudo-random to enhance security.

A feature of the present disclosure includes MOM material Features: integrating a security feature into MOM by: embedding covert markers or overt visual cues within the 3D image, such as: micro-text or nano-text visible only under specific lighting conditions; color-shift effects that are verifiable through specialized viewing devices; encoding data within the microstructure patterns of the MOM, where: the encoded data could include serial numbers, timestamps, or unique identifiers; the data is retrievable only with proprietary decoding methods or under specific illumination; (d) fabricating the MOM with the integrated security features by: using lithography or another high-precision manufacturing technique to apply the designed microstructures to the substrate; aligning the fabricated MOM with the 3D image to ensure the security features are correctly displayed or concealed; wherein the method provides a novel security-enhanced MOM and 3D image system, characterized by its use of AI for 3D image generation tailored to the specific optical characteristics of the MOM, thereby creating a product with high security integrity and visual complexity that is difficult to counterfeit.

In an exemplary embodiment of a secure three-dimensional (3D) imaging system includes a processor and a memory storing instructions executable by the processor, a Three Dimensional Generative Pre-trained Transformer (3DGPT) model configured to receive a single two-dimensional (2D) RGB image and generate a 3D depth map via monocular depth estimation, wherein the 3DGPT model comprises an encoder-decoder neural network trained on proprietary datasets including paired RGB images and ground truth depth maps with key subject, foreground, and background elements, a Micro Optical Material (MOM) layer integrated with the generated 3D depth map, the MOM layer comprising lenticular lenses and microstructures configured to produce parallax effects, and security features embedded in the MOM layer, including at least one of micro-text, holograms, lenticular line frequency variations, or encoded data, configured to resist counterfeiting.

In a second exemplary embodiment of a method for generating secure 3D images, includes selecting and preparing proprietary datasets comprising paired RGB images and ground truth depth maps with key subject, foreground, and background elements, training a Three Dimensional Generative Pre-trained Transformer (3DGPT) model on the datasets using an encoder-decoder neural network with optimized loss functions, receiving a single 2D RGB image and generating a 3D depth map via monocular depth estimation with the trained 3DGPT model, integrating the 3D depth map with a Micro Optical Material (MOM) layer comprising lenticular lenses and microstructures for parallax effects, and embedding security features in the MOM layer, including at least one of micro-text, holograms, lenticular line frequency variations, encoded data.

In a third exemplary embodiment of a 3D display stack structure includes a thin-film transistor (TFT) glass layer configured for pixel control, a TFT polarizer coupled to the TFT glass layer for light filtering, a color filter (CF) glass layer with RGB sub-pixels, positioned adjacent to the TFT glass layer, a CF polarizer coupled to the CF glass layer for light modulation, a Micro Optical Material (MOM) layer comprising lenticular lenses and microstructures for parallax effects and security features, liquid optically clear adhesive (LOCA) bonding the TFT glass layer and the CF glass layer, optically clear adhesive (OCA) bonding the MOM layer to a protective cover layer, and the protective cover layer configured for stereoscopic visualization of AI-generated 3D images integrated with the security features.

In a fourth exemplary embodiment of a non-transitory computer-readable medium storing instructions for a Secure Pattern Recognition (SPR) application, the instructions, when executed by a processor of a mobile device, the device to capture an image of a secure 3D material using a high-resolution camera, preprocess the image with edge detection, noise reduction, and contrast enhancement, analyze the image using computer vision to detect and authenticate security features embedded in a Micro Optical Material (MOM) layer, including at least one of micro-text, holograms, lenticular line frequency variations, or encoded data, and provide real-time feedback confirming authenticity based on the analysis.

These and other features of the Three Dimensional Generative Pre-trained Transformer and methods of use will become more apparent to one skilled in the art from the prior Summary and following Brief Description of the Drawings, Detailed Description of exemplary embodiments thereof, and Claims when read in light of the accompanying Drawings or Figures.

### BRIEF DESCRIPTION OF THE DRAWINGS

The present disclosure for Three Dimensional Generative Pre-trained Transformer and methods of use will be better understood by reading the Detailed Description of the Preferred and Selected Alternate Embodiments with reference to the accompanying drawing Figures, in which like reference numerals denote similar structure and refer to like elements throughout, and in which:

FIG. 1 is a block diagram of an exemplary embodiment of a computer system that provides a suitable environment for implementing select embodiments of the disclosure;

FIG. 2 is a diagram depicting an exemplary embodiment of a communication system in which concepts consistent with the present disclosure may be implemented;

FIG. 3A is block diagram of an exemplary embodiment of a Large Vision Model (LVM) AI Three Dimensional Generative Pre-trained Transformer according to select embodiments of the disclosure;

FIG. 3B is flowchart diagram of an exemplary embodiment of steps of generating a Large Vision Model (LVM) AI Three Dimensional Generative Pre-trained according to select embodiments of the disclosure;

FIG. 3C is a picture of a Scene with various gray scale depth maps of the Scene according to select embodiments of the disclosure;

FIG. 4A is block diagram of an exemplary embodiment of an anti-counterfeiting and detection system according to select embodiments of the disclosure;

FIG. 4B is flowchart diagram of an exemplary embodiment of steps of an anti-counterfeiting and detection system according to select embodiments of the disclosure;

FIG. 4C is an image of an interphased micro-text printed on Micro Optical Materials (MOMs) by cylinder to create visually complex, tamper-resistant products and packaging that are difficult to counterfeit, enhancing security for applications like documents, tickets, currency, IDs, virtual reality, and stereoscopic displays, according to select embodiments of the disclosure;

FIG. 4D is an image of an lenticular line frequency variations formed in the Micro Optical Materials (MOMs) to create visually complex, tamper-resistant products and packaging that are difficult to counterfeit, enhancing security for applications like documents, tickets, currency, IDs, virtual reality, and stereoscopic displays, according to select embodiments of the disclosure;

FIG. 5 is a cross-sectional view of a three-dimensional (3D) display stack structure with a Micro Optical Materials (MOMs) layer, according to select embodiments of the disclosure;

FIG. 6 is a cross-sectional view of a lenticular lens profile, according to select embodiments of the disclosure;

FIG. 7A is a front view of a single camera device to capture a single RGB image, according to select embodiments of the disclosure; and

FIG. 7B is flowchart diagram of an exemplary embodiment of steps of an application to confirm or verify, according to select embodiments of the disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

In describing the exemplary embodiments of the present disclosure, as illustrated in the figures, specific terminology is employed for clarity. The present disclosure, however, is not intended to be limited to the specific terminology selected; it is to be understood that each specific element includes all technical equivalents that operate in a similar manner to accomplish similar functions. Embodiments of the claims may, however, be embodied in many different forms and should not be construed as limited to the embodiments set forth herein. The examples set forth herein are non-limiting examples and are merely examples among other possible examples. It is recognized herein that the optimum dimensional relationships, to include variations in size, materials, shape, form, position, connection, function and manner of operation, assembly and use, are intended to be encompassed by the present disclosure.

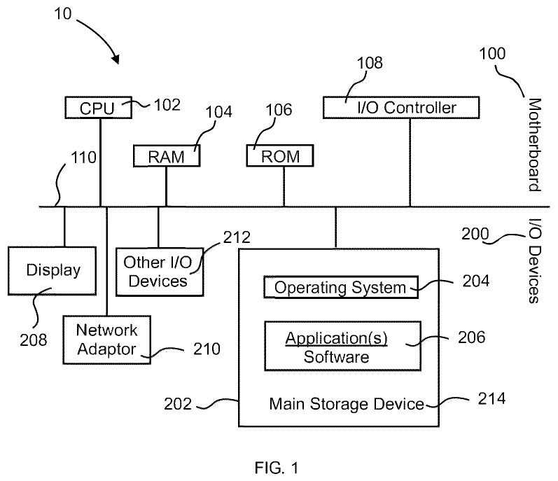

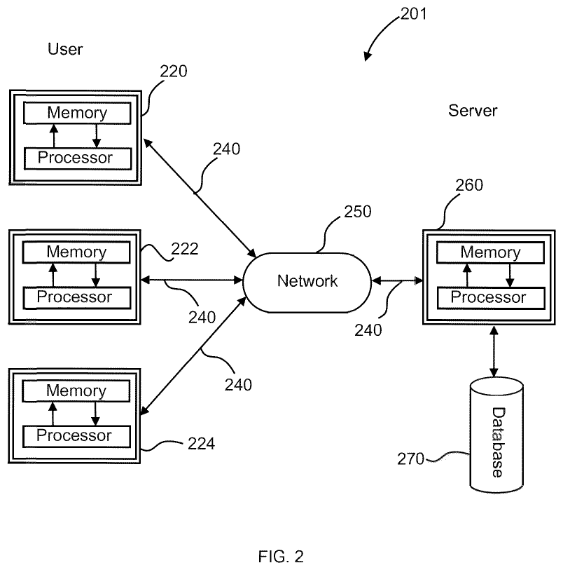

In describing the exemplary embodiments of the present disclosure, as illustrated in FIGS. 1-2, specific terminology is employed for the sake of clarity. The present disclosure, however, is not intended to be limited to the specific terminology so selected, and it is to be understood that each specific element includes all technical equivalents that operate in a similar manner to accomplish similar functions. The claimed invention may, however, be embodied in many different forms and should not be construed to be limited to the embodiments set forth herein. The examples set forth herein are non-limiting examples and are merely examples among other possible examples.

To understand the present disclosure certain variables, need to be defined. The object field is the entire image being composed. The “key subject point” is defined as the point where the scene converges, i.e., the point in the depth of field that always remains in focus and has no parallax differential. The foreground and background points are the closest point and furthest point from the viewer, respectively. The depth of field is the depth or distance created within the object field (depicted distance from foreground to background). The principal axis is the line perpendicular to the scene passing through the key subject point. The parallax is the displacement of the key subject point from the principal axis. In digital composition the displacement is always maintained as a whole integer number of pixels from the principal axis.

As will be appreciated by one of skill in the art, the present disclosure may be embodied as a method, data processing system, or computer program product. Accordingly, the present disclosure may take the form of an entirely hardware embodiment, entirely software embodiment or an embodiment combining software and hardware aspects. Furthermore, the present disclosure may take the form of a computer program product on a computer-readable storage medium having computer-readable program code means embodied in the medium. Any suitable computer readable medium may be utilized, including hard disks, ROM, RAM, CD-ROMs, electrical, optical, magnetic storage devices and the like.

The present disclosure is described below with reference to flowchart illustrations of methods, apparatus (systems) and computer program products according to embodiments of the present disclosure. It will be understood that each block or step of the flowchart illustrations, and combinations of blocks or steps in the flowchart illustrations, can be implemented by computer program instructions or operations. These computer program instructions or operations may be loaded onto a general-purpose computer, special purpose computer, or other programmable data processing apparatus to produce a machine, such that the instructions or operations, which execute on the computer or other programmable data processing apparatus, create means for implementing the functions specified in the flowchart block or blocks/step or steps.

These computer program instructions or operations may also be stored in a computer-usable memory that can direct a computer or other programmable data processing apparatus to function in a particular manner, such that the instructions or operations stored in the computer-usable memory produce an article of manufacture including instruction means which implement the function specified in the flowchart block or blocks/step or steps. The computer program instructions or operations may also be loaded onto a computer or other programmable data processing apparatus (processor) to cause a series of operational steps to be performed on the computer or other programmable apparatus (processor) to produce a computer implemented process such that the instructions or operations which execute on the computer or other programmable apparatus (processor) provide steps for implementing the functions specified in the flowchart block or blocks/step or steps.

Accordingly, blocks or steps of the flowchart illustrations support combinations of means for performing the specified functions, combinations of steps for performing the specified functions, and program instruction means for performing the specified functions. It should also be understood that each block or step of the flowchart illustrations, and combinations of blocks or steps in the flowchart illustrations, can be implemented by special purpose hardware-based computer systems, which perform the specified functions or steps, or combinations of special instructions or operations. Computer programming purpose for hardware implementing and the computer present disclosure may be written in various programming languages, database languages, and the like. However, it is understood that other source or object-oriented programming languages, and other conventional programming language may be utilized without departing from the spirit and intent of the present disclosure.

Referring now to FIG. 1, there is illustrated a block diagram of a computer system 10 that provides a suitable environment for implementing embodiments of the present disclosure. The computer architecture shown in FIG. 1 is divided into two parts-motherboard 100 and the input/output (I/O) devices 200. Motherboard 100 preferably includes subsystems or processor to execute instructions such as central processing unit (CPU) 102, a memory device, such as random-access memory (RAM) 104, input/output (I/O) controller 108, and a memory device such as read-only memory (ROM) 106, also known as firmware, which are interconnected by bus 110. A basic input output system (BIOS) containing the basic routines that help to transfer information between elements within the subsystems of the computer is preferably stored in ROM 106 or operably disposed of in RAM 104. Computer system 10 further preferably includes I/O devices 202, such as main storage device 214 for storing operating system 204 and instructions or application program(s) 206, and display 208 for visual output, and other I/O devices 212 as appropriate. Main storage device 214 preferably is connected to CPU 102 through a main storage controller (represented as 108) connected to bus 110. Network adapter 210 allows the computer system to send and receive data through communication devices or any other network adapter capable of transmitting and receiving data over a communications link that is either a wired, optical, or wireless data pathway. It is recognized herein that central processing unit (CPU) 102 performs instructions, operations or commands stored in ROM 106 or RAM 104.

Many other devices or subsystems or other I/O devices 212 may be connected in a similar manner, including but not limited to, devices such as microphone, speakers, flash drive, CD-ROM player, DVD player, printer, main storage device 214, such as hard drive, and/or modem each connected via an I/O adapter. Also, although preferred, it is not necessary for all the devices shown in FIG. 1 to be present to practice the present disclosure, as discussed below. Furthermore, the devices and subsystems may be interconnected in different configurations from that shown in FIG. 1, or may be based on optical or gate arrays, or some combination of these elements that can respond to and execute instructions or operations. The operation of a computer system such as that shown in FIG. 1 is readily known in the art and is not discussed in further detail in this application, so as not to overcomplicate the present discussion.

Referring now to FIG. 2, there is illustrated a diagram depicting an exemplary communication system 201 in which concepts consistent with the present disclosure may be implemented. Examples of each element within the communication system 201 of FIG. 2 are broadly described above with respect to FIG. 1. In particular, the server system 260 and user system 220, 222, 224 have attributes similar to computer system 10 of FIG. 1 and illustrate one possible implementation of computer system 10. Communication system 201 preferably includes one or more user system(s) 220, 222, 224, one or more server system(s) 260, and one or more network(s) 250, which could be, for example, the Internet, public network, private network or cloud. User systems 220, 222, and 224 each preferably include a computer-readable medium, such as random-access memory, coupled to a processor. The processor, CPU 102, executes program instructions or operations stored in memory. Communication system 201 typically includes one or more user system(s) 220, 222, 224. For example, user system 220 may include one or more general-purpose computers (e.g., personal computers), one or more special purpose computers (e.g., devices specifically programmed to communicate with each other and/or the server system 260), a workstation, a server, a device, a digital assistant or a “smart” cellular telephone or pager, a digital camera, a component, other equipment, or some combination of these elements that is capable of responding to and executing instructions or operations.

Similar to user system 220, server system 260 preferably includes a computer-readable medium, such as random-access memory, coupled to a processor. The processor executes program instructions stored in memory. Server system 260 may also include a number of additional external or internal devices, such as, without limitation, a mouse, a CD-ROM, a keyboard, a display, a storage device and other attributes similar to computer system 10 of FIG. 1. Server system 260 may additionally include a secondary storage element, such as database 270 for storage of data and information. Server system 260, although depicted as a single computer system, may be implemented as a network of computer processors. Memory in server system 260 contains one or more executable steps, program(s), algorithm(s), or application(s) 206 (shown in FIG. 1). For example, the server system 260 may include a web server, information server, application server, one or more general-purpose computers (e.g., personal computers), one or more special purpose computers (e.g., devices specifically programmed to communicate with each other), a workstation, or runs on edge GPU with 4 GB VRAM or other latest hardware, or other equipment, or some combination of these elements that is capable of responding to and executing instructions or operations.

Communications system 201 can deliver and exchange data between user system 220 and server system 260 through communications link 240 and/or network 250. Through user system 220, users can preferably communicate over network 250 with each other user system 222, 224, and with other systems and electronic devices, such as server system 260, to transmit, store, print and/or view multidimensional digital master image(s). Communications link 240 typically includes network 250 making a direct or indirect communication between the user system 220 and the server system 260, irrespective of physical separation. Examples of a network 250 include the Internet, cloud, analog or digital wired and wireless networks, radio, television, cable, satellite, and/or any other delivery mechanism for carrying and/or transmitting data or other information, such as to electronically transmit, store, print and/or view multidimensional digital master image(s). The communications link 240 may include, for example, a wired, wireless, cable, optical or satellite communication system or other pathway.

It is contemplated herein that RAM 104, main storage device 214, and database 270 may be referred to herein as storage device(s) or memory device(s).

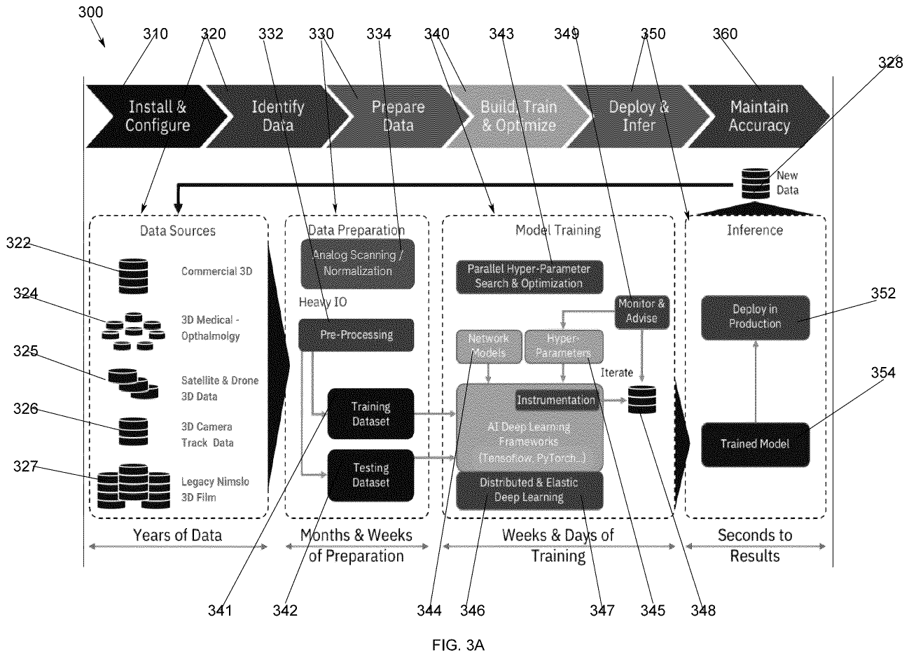

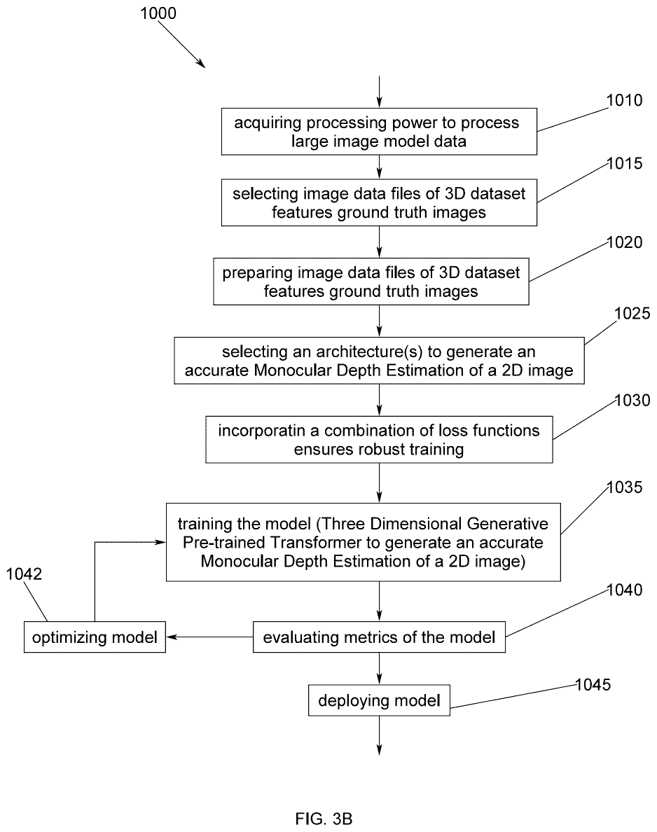

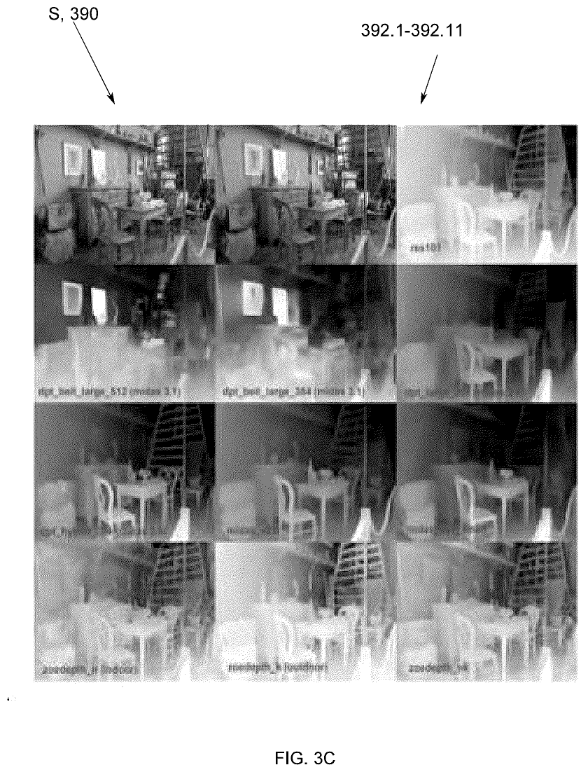

Referring now to FIGS. 3A, 3B, and 3C, by way of example, and not limitation, there is illustrated an example embodiment of a block diagram of an exemplary embodiment of a Large Vision Model (LVM) AI Three Dimensional Generative Pre-trained Transformer 300, a flowchart diagram 1000 of an exemplary embodiment of steps of generating a Large Vision Model (LVM) AI Three Dimensional Generative Pre-trained Transformer, and picture 390 of scene S with various gray scale depth maps DM 392.1-392.11 of scene S.

The present disclosure relates to systems and methods for developing three-dimensional (3D) generative pre-trained transformer (3DGPT) model 300, specifically tailored for high-accuracy monocular depth estimation utilizing proprietary three-dimensional (3D) image datasets 321. Three-dimensional (3D) generative pre-trained transformer (3DGPT) model 300 leverages extensive private and public datasets 321, including, but not limited to, commercial 3D 322, 3D medical ophthalmology 324, satellite and drone 3D data 325, 3D camera data 326, legacy NIMSLO 3Dfilm data, camera track data, including ground truth images and legacy 3D captures, to train large vision models (LVMs) capable of recognizing and predicting dimensional disparities from single two-dimensional (2D) images. This facilitates applications in security printing, mobile devices, medical imaging, subsurface and overhead imaging, anti-counterfeiting, cybersecurity, and earth observation.

FIG. 3C illustrate exemplary embodiments of the monocular depth. FIG. 3C depicts a comparative visualization of monocular depth estimation outputs, showcasing high-accuracy depth maps generated by the 3DGPT model 300 trained on Treis D's extensive 3D ground truth datasets 321 of scene S. The figure includes a grid of gray scale depth maps DM 392.1-392.11 of scene S produced by various architectures and variants (e.g., “dpt_belt_large_512 (midas 3.1)”, “dpt_large_384 (midas 3.1)”, “zoedepth_n (indoor)”, “zoedepth_k (outdoor)”, and others), compared against baselines like “groundtruth”, “res101”, and “midas_v21”. These visualizations demonstrate the model's superior performance in estimating depth from a single RGB image of an indoor scene S (e.g., a room with furniture, ladders, and objects), highlighting smooth transitions, edge preservation, and accurate disparity recognition.

FIG. 3B provides a flowchart of an exemplary method for creating, training, evaluating, optimizing, and deploying the monocular depth estimation model 1000. Method 1000 having sequential steps (1010 through 1045) executed by one or more computing systems 100, 201, including processors, memory, storage devices, and access to cloud-based resources for handling large-scale data processing. Machine learning frameworks such as PyTorch or TensorFlow are employed to implement the neural networks. System 1000 may interface with databases, APIs, and cloud storage for data ingestion and model deployment.

The present disclosure overcomes the challenges above by employing TreisD's proprietary 3D datasets 321, accumulated over decades, which encompasses ground truth images from specialized systems such as legacy Nimslo 3D 327, Autotrak3D 326, Nidek 3D medical imaging 324, 3D earth observation platforms 325, and commercial 3D 322 collections.

The 3DGPT model 300 adapts principles from large language models (LLMs) to visual domains, forming an LVM specialized in dimensional disparity recognition. By training on current and legacy 3D images, the model generates high-accuracy grayscale depth maps, as exemplified in FIG. 3C, enabling real-time applications in AR/VR, robotics, medical diagnostics, and security systems where precise depth perception is essential. 3DGPT model 300 includes multi-objective optimization with supervised, regularization, and photometric losses for scale and bias adaptation.

As illustrated in FIGS. 3A and 3B, the method 1000 initiates with data selection (Step 1015, and block 320) and data preparation (Step 1020, and block 330), proceeds to resource acquisition (Step 1010) and architecture selection (Step 1025, and block 340), incorporates loss functions (Step 1030), involves training (Step 1035, and block 340), evaluation (Step 1040, and block 349), optimization (Step 1042, and block 343), and culminates in deployment (Step 1045, and step 352). These steps ensure the development of a robust 3DGPT model 300 capable of predicting depth maps with high fidelity, as demonstrated by the comparative outputs in FIG. 3C.

Step 1015: Selecting Image Data Files of 3D Dataset Featuring Ground Truth Images. Referring again to FIG. 3B, the process begins with selecting image data files from a comprehensive 3D dataset. This dataset includes TreisD's private collection of ground truth images, which serve as the foundation for training. Ground truth images are paired RGB-depth captures where depth values are accurately known, derived from custom 3D cameras and historical formats like Nimslo 3D 327 and Autotrak3D 326. Additional sources may include public datasets with depth maps such as NYU Depth v2, KITTI, and ETH3D for benchmarking, as well as synthetic data generated via tools like Blender or Unity to simulate diverse scenes. Analog data, such as photographic negatives 327 from multi-view captures derive depth from disparities (stereo data), are also selected and digitized. Selection criteria prioritize diversity in scenes (e.g., indoor medical environments, outdoor earth observations) to enhance model generalization.

Step 1020: Preparing Image Data Files of 3D Dataset Featuring Ground Truth Images. Data preparation 330 as shown in FIG. 3A, involves analog scanning/normalization 334, preprocessing 332, cleaning, and structuring the selected datasets for efficient model training. This step develops data pipelines and extract-transform-load (ETL) processes to handle structured and unstructured data from various sources, including databases, APIs, and cloud storage.

A. Collection and Organization: RGB images are paired with grayscale depth maps. For instances lacking direct depth, disparities from stereo or multi-view images are computed to derive depths. Synthetic scenes with known depths augment the dataset, while analog negatives are scanned and normalized for digital compatibility.

B. Preprocessing: RGB images are normalized by scaling pixel values to [0, 1] or [−1, 1]. Depth maps are scaled to [0, 1] for relative representation or retained in metric units (e.g., meters). Data augmentation applies transformations like cropping, resizing, flipping, and color jittering to increase diversity. Multi-view images are aligned using feature matching to ensure consistency.

C. Train/Test Split: The dataset is partitioned into training data set 341, validation dat sets, and test data sets 342 (e.g., 80%/10%/10%), with stratification to maintain scene diversity across splits. This preparation ensures the data is optimized for large-scale processing, directly supporting the high-accuracy outputs visualized in FIG. 3C.

Step 1010: Acquiring Processing Power to Process Large Image Model Data. To handle the computational demands of training on extensive datasets, this step acquires necessary processing resources, as depicted in block 346, 347, and FIG. 1. This may involve provisioning GPU clusters, cloud-based accelerators (e.g., via AWS, GCP, or Azure), or distributed computing frameworks. Resource allocation is scaled based on dataset size and model complexity, ensuring efficient handling of high-resolution images and batch processing without bottlenecks.

Step 1025: Selecting an Architecture(s) to Generate an Accurate Monocular Depth Estimation of a 2D Image. FIG. 3B highlights the selection of neural network architectures 346, 347, and FIG. 1 suited for monocular depth estimation, drawing from machine learning, deep learning, natural language processing (NLP), and computer vision techniques for 3D stereoscopic imaging.

Monocular depth map generation is performed utilizing different methods, however more specifically depth map estimate may be performed as set forth in René Ranftl et al., Towards Robust Monocular Depth Estimation: Mixing Datasets for Zero-shot Cross-dataset Transfer, 44 IEEE Trans. Pattern Analysis & Machine Intelligence 1623 (2022) incorporated herein in its entirety by reference.

Method 300 for robust monocular depth estimation from a single input image of scene S, comprising training 340 a deep neural network model 346 on a diverse mixture of datasets 321 to predict disparity maps that are invariant to variations in depth range, scale, and shift. In one embodiment, method 300 involves preprocessing multiple complementary training datasets 321, each providing RGB images paired with ground-truth depth annotations in varying forms, such as absolute depth from RGB-D sensors, relative depth from structure-from-motion (SfM) reconstructions, or disparity from stereo pairs with unknown calibrations, which encompasses ground truth images from specialized systems such as legacy Nimslo 3D 327, Autotrak3D 326, Nidek 3D medical imaging 324, 3D earth observation platforms 325, and commercial 3D 322 collections. To address incompatibilities among datasets, neural network 300 may be configured to output predictions in disparity space (inverse depth up to unknown scale and shift), enabling unified training across sources like indoor RGB-D collections (e.g., DIML Indoor), SfM-based outdoor scenes (e.g., MegaDepth), web-sourced stereo videos (e.g., WSVD), curated stereo datasets (e.g., ReDWeb), and a novel dataset derived from 3D stereoscopic films. The 3D movie dataset is extracted by selecting high-quality films shot with physical stereo cameras, preprocessing frames to remove artifacts, and computing disparity maps via optical flow algorithms with left-right consistency checks and sky region masking to ensure reliable relative depth ground truth.

The training process 354 employs a scale-and shift-invariant loss function to handle ambiguities in ground-truth representations, wherein predictions and ground truth are aligned using estimators for scale and translation, such as least-squares fitting for mean-squared error variants or robust median-based alignment for absolute error or trimmed residuals to mitigate outliers from imperfect annotations. A regularization term, adapted from multi-scale gradient matching in disparity space, is incorporated to enforce sharp discontinuities aligned with ground-truth edges. Dataset mixing is optimized via either a naive uniform sampling strategy or a principled multi-objective optimization approach that seeks Pareto-optimal solutions across tasks defined by each dataset, ensuring balanced learning without dominance by any single source's biases. The neural network 300 architecture utilizes a high-capacity encoder, such as a ResNet-based model pretrained on auxiliary tasks like ImageNet classification, coupled with a multi-scale decoder to regress dense disparity maps. Pretraining 332 enhances generalization, and the model is fine-tuned using stochastic optimization (e.g., Adam) on minibatches drawn from the mixed datasets. Encoder optimized loss functions invariant to depth range, scale, and biases, including supervised losses, regularization losses, and photometric losses.

In operation, for depth map estimation, the trained model 300 receives a monocular RGB image as input and directly regresses a disparity map, which can be converted to a depth map if metric scale is available or desired. The method 300 demonstrates superior zero-shot cross-dataset transfer, evaluating performance on unseen datasets (e.g., DIW, ETH3D, Sintel, KITTI, NYUDv2, TUM-RGBD) without fine-tuning, outperforming prior art in accuracy and robustness across diverse environments including indoor, outdoor, static, and dynamic scenes. This approach mitigates limitations of individual datasets, such as sparse annotations or environmental biases, by leveraging their complementary strengths, thereby providing a scalable and generalizable solution for applications in computer vision, robotics, security, and augmented reality.

A. Encoder-Decoder Architecture: The encoder (e.g., ResNet, EfficientNet, or MobileNet) extracts features from the input RGB image, while the decoder up-samples these to produce dense depth maps. Encoder-decoder optimized loss functions invariant to depth range, scale, and biases, including supervised losses, regularization losses, and photometric losses.

B. Variants: U-Net with skip connections preserves spatial details; attention mechanisms focus on relevant regions; multi-scale supervision predicts depths at varying resolutions for robust learning.

C. Multi-View Integration: Reprojection losses and epipolar geometry constraints enforce consistency across views, comparing predicted depths against ground truth disparities.

These architectures are chosen to optimize for pixel-wise accuracy, as evidenced by the refined depth maps in FIG. 3C (e.g., “dpt_hybrid_384 (Midas 3.0)” outperforming baselines).

Step 1030: Incorporating a Combination of Loss Functions to Ensure Robust Training. A multifaceted loss framework is incorporated, as shown in FIG. 3B, to guide training effectively.

Supervised Loss: L1/L2 differences between predicted and ground truth depths; scale-invariant losses for relative disparities.

Regularization Loss: Edge-aware smoothness encourages gradual transitions while preserving edges.

Photometric Loss: For multi-view data, minimizes differences between reprojected and original images.

This combination ensures the model's robustness, contributing to the high-accuracy estimations in FIG. 3C.

Step 1035: Training the Model (Three Dimensional Generative Pre-Trained Transformer 300 to generate an accurate monocular depth estimation of a 2D Image). Training 340 utilizes frameworks like PyTorch, TensorFlow, or Keras, as illustrated in FIGS. 3A, 346.

Distributed and elastic deep learning, 347.

Iterate 348.

Hyperparameters 343, 345: Learning rate starts at 1e-4; batch size maximizes GPU capacity; optimizers include Adam or AdamW. Search and Optimization 343. Network models 343.

Training Strategy: Supervised on single images with depth losses; multi-view with reprojection and photometric losses.

Data Augmentation: Real-time applications of flipping, cropping, and brightness adjustments.

The 3DGPT model 300 may be iteratively refined to predict accurate depth maps from 2D inputs.

Step 1040: Evaluating Metrics of the Model. Evaluation, per FIG. 3B, assesses performance on test sets.

Depth Accuracy: RMSE, Absolute Relative Difference, Log10 error.

Qualitative: Visualization of depth maps (as in FIG. 3C) for perceptual quality.

Robustness: Testing on unseen scenes for generalization.

Step 1042: Optimizing Model 354. Optimization fine-tunes for inference, as shown in FIG. 3B: quantization and pruning reduce model size; export to ONNX for portability. Domain-specific fine-tuning adapts for tasks like anti-counterfeit imaging.

Step 1045: Deploying Model 352. Deployment integrates the model into production, using cloud platforms, containerization (Docker, Kubernetes), and APIs for real-time systems in AR/VR, robotics, medical imaging, cybersecurity, or observation applications.

Tools and Resources. Datasets include TreisD ground truth 321, NYU Depth v2, KITTI, ETH3D. Frameworks: PyTorch, TensorFlow, JAX. Libraries: OpenCV, torchvision, albumentations.

Embodiments may incorporate NLP for multimodal inputs. Hardware includes GPUs for training and edge devices for inference.

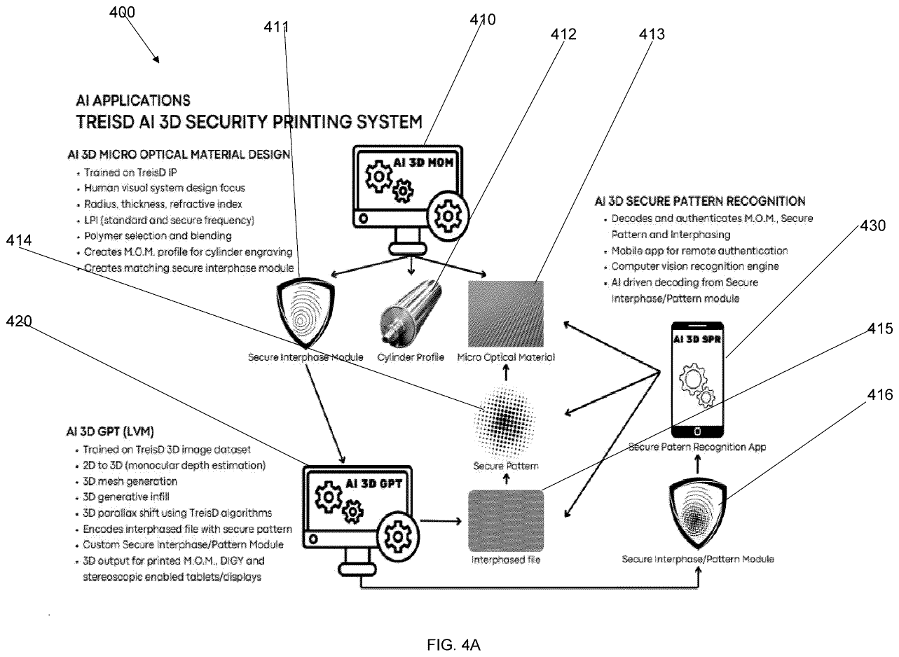

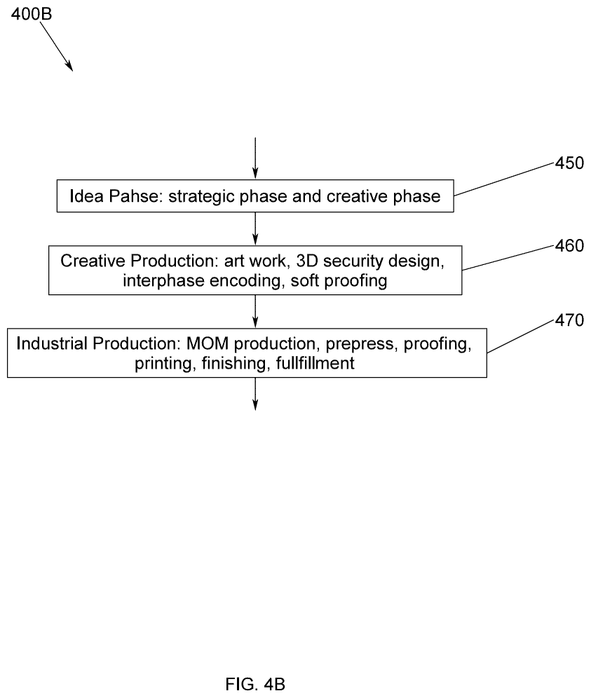

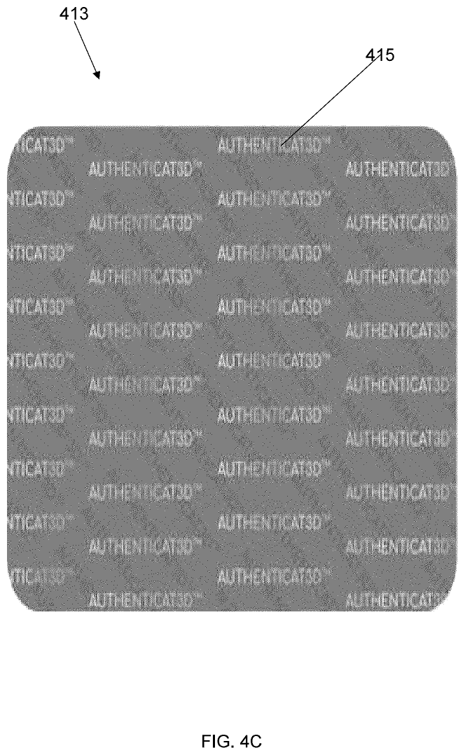

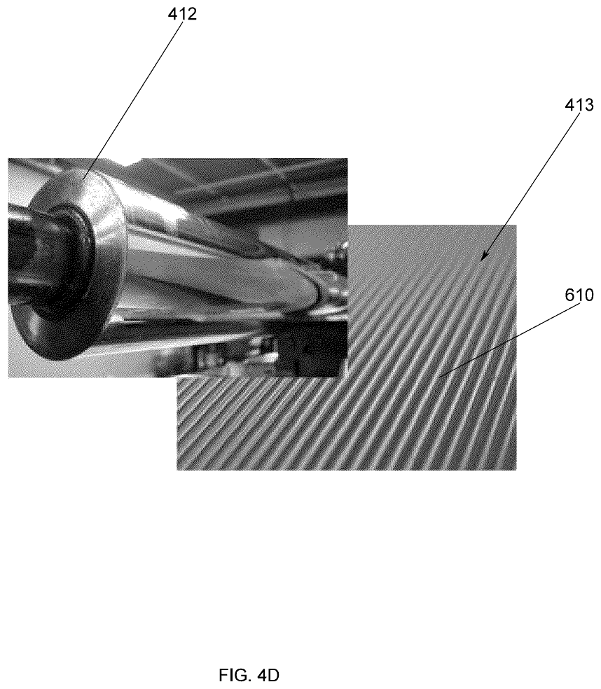

Referring now to FIGS. 4A, 4B, and 4C, by way of example, and not limitation, there is illustrated an example embodiment of is block diagram of an exemplary embodiment of an anti-counterfeiting and detection system, a flowchart diagram of an exemplary embodiment of steps of an anti-counterfeiting and detection system, an image of an interphased micro-text printed on Micro Optical Materials (MOMs) to create visually complex, tamper-resistant products and packaging that are difficult to counterfeit, enhancing security for applications like documents, tickets, currency, IDs, virtual reality, and stereoscopic displays, and an image of a lenticular line frequency variations formed in the Micro Optical Materials (MOMs) to create visually complex, tamper-resistant products and packaging that are difficult to counterfeit, enhancing security for applications like documents, tickets, currency, IDs, virtual reality, and stereoscopic displays.

The present disclosure relates to a system and method for AI-assisted micro-optical 3D security printing 400, incorporating artificial intelligence for material design, pattern recognition, and secure interphasing 415, coupled with an industrial production workflow for manufacturing secure micro-optical materials (M.O.M.). System 400 enhances security features in printed materials, such as anti-counterfeiting elements for documents, packaging, and displays, by leveraging AI-driven design and authentication processes integrated with high-throughput manufacturing equipment.

FIG. 4A illustrates an exemplary diagram of AI applications in the micro-optical 3D security printing system 400. As shown in FIG. 4A, system 400 includes three primary AI modules: AI 3D Micro Optical Material Design (AI 3D MOM) 410, AI 3D GPT (Large Vision Model, LVM) 420, and AI 3D Secure Pattern Recognition (AI 3D SPR) 430. These modules operate in conjunction to design, generate, and authenticate(ing) secure micro-optical structures, secure features.

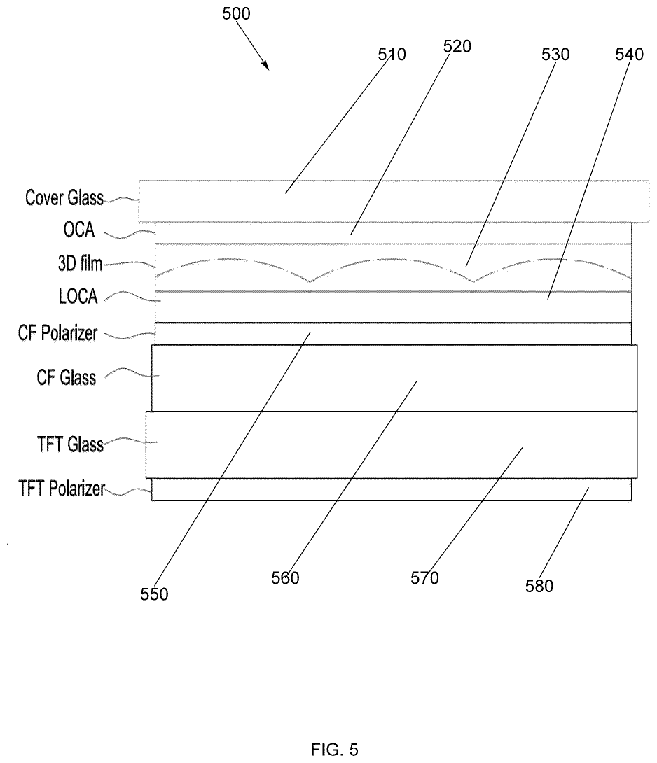

AI 3D MOM module 410 is trained via FIG. 3 with a focus on human visual system design principles. It processes inputs including radius, thickness, refractive index, lines per inch (LPI) for both standard and secure frequencies, and polymer selection and blending. Module 410 generates M.O.M. 413 (example shown in FIG. 4D) profile suitable for cylinder 412 engraving, which defines the micro-optical lens structures of FIG. 5, such as lenticular arrays or holographic elements, to produce 3D visual effects. Additionally, module 410 creates a matching secure interphase module 411, which embeds encrypted secure patterns 414 or interphased data 415 (example shown in FIG. 4C) into the material profile to enhance security. For example, secure interphase module 411 may incorporate frequency-modulated patterns that are invisible to the naked eye but detectable under specific conditions, thereby preventing unauthorized replication.

It is contemplated herein that interphased data 415 (example shown in FIG. 4C) may include text, color, images, and other content detectable visually or by verification system 700..

Connected to AI 3D MOM 410 output, as depicted in FIG. 4A, is cylinder profile 412 412, which is engraved onto physical cylinder 412 for use in material production, M.O.M. 413 (example shown in FIG. 4D). This profile interacts with the micro-optical material 413 to form the base substrate with embedded optical features. Secure interphase module 411 ensures that the engraved patterns include anti-tampering elements, such as variable refractive indices or blended polymers that alter light refraction in unique ways.

It is contemplated herein that profile interacts with the micro-optical material 413 to form the base substrate with embedded optical features may generate repeating lens on micro-optical material 413 with various frequency spacing, groups of frequency spacing, and the like detectable by verification system 700.

AI 3D GPT (LVM) module 420 is trained via FIG. 3, to perform advanced image and pattern processing. It converts 2D inputs to 3D representations through monocular depth estimation, generates 3D meshes with infill, and applies 3D parallax shifts using proprietary algorithms. Module 420 encodes interphased files 415 (example shown in FIG. 4C) with secure patterns 414, creating a custom secure interphase/pattern module 411. Outputs from this module are compatible with printed M.O.M. 413, digital graphics interchange (DIGY) formats, and stereoscopic-enabled tablets or displays. For example, the AI 3D GPT can generate an interphased file 415 that embeds a secure pattern 414 into a 3D model, which is then outputted for printing or digital rendering, ensuring that the final product includes tamper-evident features.

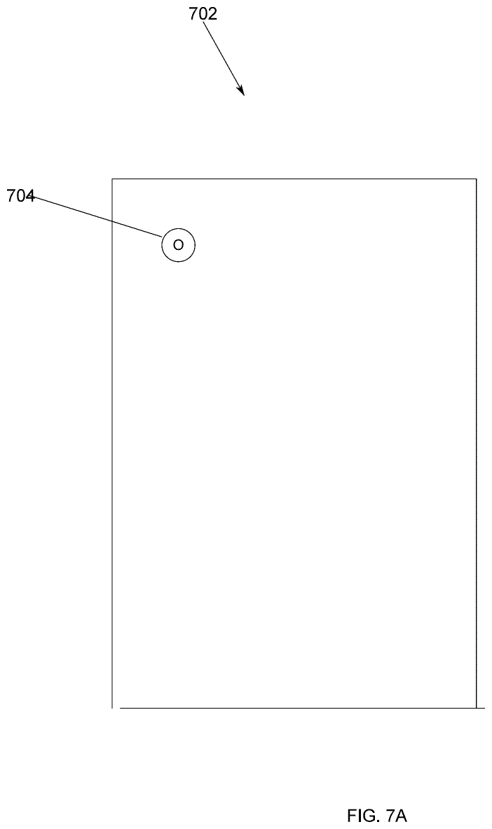

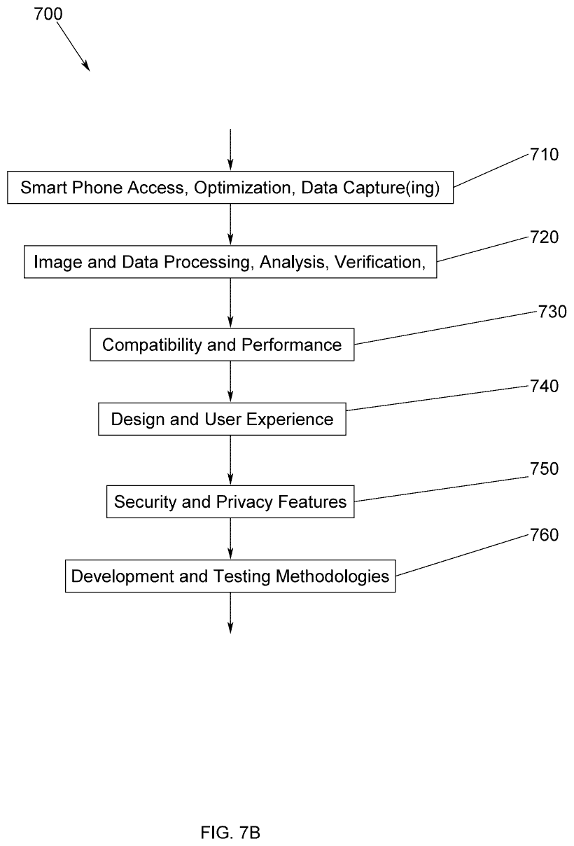

AI 3D SPR module 430 provides detection and authentication (authenticating) capabilities for M.O.M. 413 secure patterns 414, interphasing 415, and combinations 416 thereof, Secure Features. It utilizes computer vision recognition techniques to decode and verify patterns from secure interphase module 411. This module 430 supports mobile applications for remote authentication (authenticating), allowing users to scan printed materials via a smartphone camera, or other scanning technology. For instance, the AI-driven decoding process may employ machine learning algorithms to analyze parallax shifts or depth cues in the micro-optical structures, confirming authenticity by matching against encoded secure patterns 414, interphasing 415, and combinations 416 thereof. The module can authenticate patterns in real-time, making it suitable for applications in secure documents, currency, IDs, banknotes, tickets, packaging, or product labels. Moreover, this application, AI 3D SPR module 430 supports offline functionality wherein device like smart phone 702 in FIG. 7A may operate offline, support high-resolution image captures of at least 48 megapixels via camera 704, and comply with data protection regulations for secure image storage and processing.

As illustrated in FIG. 4A, the workflow integrates these AI modules sequentially: the AI 3D MOM feeds into secure interphase module 411 and cylinder profile 412, which informs the micro-optical material. This material is then processed by the AI 3D GPT to produce interphased file 415 with secure pattern 414, ultimately authenticated via secure pattern 414 recognition app connected to the AI 3D SPR.

The industrial production aspect of the invention is depicted in the workflow diagram (referred to herein as FIG. 1 for clarity, encompassing the production sequence). FIG. 1 outlines a multi-stage manufacturing process for producing micro-optical 3D security materials at scale, utilizing specialized equipment to handle material extrusion, conversion, printing, lamination, and finishing.

In an exemplary process the fabrication of M.O.M. 413 (example shown in FIG. 4D) begins with a cast line, such as a Collin Cast Line, which produces cast rolls of micro-optical material. This equipment is capable of processing polyethylene terephthalate glycol (PETG) and polycarbonate (PC) substrates, with initial cylinder 412 designs supporting 100 LPI, 133.3 LPI, and a third to-be-determined (TBD) configuration. A corona treater enhances ink receptivity on the material surface. The cast line operates at a throughput of approximately 100 lbs/hr, with a net width of 24 inches (610 mm), thickness range of 5-22 mil, and speed of 6 m/min at 5 mil thickness, yielding about 1,050 12×18-inch sheets per hour at 14 mil.

Next, the material rolls are converted into sheets using a sheeter, such as a Rosenthal Sheeter. This step cuts the rolls into sheets with a maximum cut width of 36.0 inches, maintaining an edge tolerance of 0.01 inches and incorporating a static eliminator to prevent material adhesion issues. The sheeter processes up to 5,000 12×18-inch sheets per hour.

The sheets then undergo digital printing via a printer, such as a Heidelberg Digital Printer. This equipment supports variable data input, enabling customization of security patterns. It includes an invisible ink system for embedding covert features at high resolutions up to 4800 DPI, managed by a Fiery Raster Image Processor (RIP) system. The printer outputs approximately 3,180 12×18-inch sheets per hour.

Following printing, the sheets are enhanced through lamination using a laminator, such as an Autobond Laminator. This modular device supports roll-to-roll and sheet-to-sheet operations, applying adhesives, foils, or peel-and-destroy layers to add security features like tamper-evident seals. It processes up to 3,500 12×18-inch sheets per hour.

The final stage involves die cutting with equipment like a Heidelberg Die Cutter, which finishes the material to precise sizes. This includes corner rounding, perforations, scoring for folds, packaging integration, and stripping for waste removal. The die cutter handles approximately 7,700 12×18-inch sheets per hour.

In operation, the AI-generated designs from FIG. 4 are integrated into the production workflow. For example, M.O.M. 413 profile and secure interphase module 411 inform cylinder 412 engraving in the cast line, while the AI 3D GPT's 420 interphased files 415 dictate the variable data printed in the digital printing stage. Authentication via AI 3D SPR 430 can be performed post-production to verify the embedded security features.

One skilled in the art will appreciate that variations may be made without departing from the spirit of the invention. For instance, the AI modules may be implemented using neural networks such as convolutional neural networks (CNNs) for computer vision tasks or generative adversarial networks (GANs) for pattern generation. The production equipment may be scaled or substituted with equivalent machinery capable of similar throughputs and precisions. The system ensures high-security printing by combining AI-driven customization with industrial-scale manufacturing, enabling applications in secure identification, packaging, and digital displays.

FIG. 4B illustrates an exemplary overview of the micro-optical 3D security printing process 400B, divided into three main phases: Idea Phase 440, Creative Production 450, and Industrial Production 460. As shown in FIG. 4B, Idea Phase 440 includes the strategic phase and creative phase, where initial concepts are developed. Creative Production 450 phase encompasses artwork, 3D security design, interphase encoding, and soft proofing. Industrial Production 470 phase covers M.O.M. 413 production, prepress, proofing, printing, finishing, and fulfillment. This phased approach ensures seamless integration from conceptualization to final product delivery, with a focus on security and scalability.

A more detailed depiction of the process is provided in the workflow diagrams (referred to herein as FIGS. 3 and 4A for clarity). FIG. 4B presents the overall process overview, expanding on FIG. 4A by outlining sub-stages and specific tasks within each phase. The process begins with the Idea Phase 450 as detailed in FIG. 4B, which is subdivided into Strategic Phase and Creative Phase.

Strategic Phase, decisions are made on the best visual features based on client requirements, governing regulations, security challenges, integration with existing products or packaging, size, quantity, materials, and finishing options. Quoting is handled through a Print Management Information System (MIS) or similar tool to provide accurate cost estimates.

Creative Phase within the Idea Phase involves initial concept development, aligning with client needs to refine ideas into actionable designs. This phase ensures that security elements are incorporated early, such as determining the use of micro-optical lenses for 3D effects or embedded patterns for authentication.

Following Idea Phase 450 is Creative Production 460 phase as detailed in FIG. 4B, which includes Artwork, 3D Security Design, Interphase Encoding, and Soft Proofing. Artwork stage, client-provided art must meet specific requirements, including uncompressed original formats (e.g., .psd, .tif, .ai, .eps), 300 dpi for raster art, layered 3D elements (foreground, key subject, background), visual authentication features like dynamic watermarks, variable data, chromatic change, repeating backgrounds, and covert features such as invisible ink. 3D Security Design stage focuses on creating secure 3D representations, interphasing artwork to match micro-optical material frequencies, and ensuring soft proofing of designs with digital 3D formats (DIGY) and stereo tablets. Interphase Encoding embeds security patterns into the design, such as frequency-modulated interphases that create parallax shifts or depth illusions visible only under certain angles or lighting conditions. Soft Proofing allows for virtual verification of the design, simulating the final printed output to identify and correct issues before physical production.

Industrial Production 470 phase, as detailed in FIG. 4B with specific equipment, handles the manufacturing workflow. This phase includes M.O.M. Production, Prepress, Proofing, Printing, Finishing, and Fulfillment. In M.O.M. Production, micro-optical material 413 is created using specialized equipment to form substrates with lenticular or holographic structures. Prepress involves creating press form layouts, engineering die lines and order dies, and producing M.O.M. 413 quality needed for the order. Proofing calibrates the press form based on pitch tests, prints contract proofs for approval, and follows quality control (QC) and continuous improvement (CI) protocols.

A list of security features that can be integrated into Micro Optical Material (MOM) 413 to enhance its anti-counterfeiting capabilities:

### Microstructures for Optical Effects

Diffraction Gratings: Creating colors and patterns visible only at certain angles.

Holographic Elements: Embedding full-color holograms or micro-holograms.

Lenticular Lenses: Producing different images or animations when viewed from different angles.

### Color-Shifting Properties

Dynamic Color Shift: Changes color based on the viewing angle or type of light.

Polarization Effects: Images or patterns visible only through polarized light.

### Hidden Images or Text

Micro-Text: Extremely small text visible only under magnification.

Nano-Text: Even smaller text requiring advanced microscopy to read.

Latent Images: Images or texts that are only visible under specific lighting conditions or angles.

### Encoded Information

Data Matrix or QR Codes: Encoded within the microstructure, requiring specific software to decode.

Serial Numbers or Unique Identifiers: Embedded in the material, visible only under certain conditions or with specific tools.

### Fluorescent Features

UV Fluorescence: Elements that glow under ultraviolet light in specific patterns or colors.

Infrared (IR) Features: Visible or changes appearance under IR illumination.

### Tamper-Evident Features

Destructible Layers: The MOM itself or parts of it are designed to be destroyed or altered upon tampering.

Reactive Inks: Change color or reveal hidden messages when tampered with or exposed to certain chemicals.

### Kinetic Images

Motion Effects: Images appear to move or change when the MOM is tilted or moved.

Parallax Effects: Multiple image layers where depth perception changes with viewing angle.

### Magnetic Properties

Magnetic Ink: Used for machine-readable security features, like in banknotes.

### Optical Variable Devices (OVD)

Holographic Optically Variable Devices: Change appearance based on the angle of light and observation.

### Multi-Layer Structures

Layered Microstructures: Different security features on different layers, requiring precise alignment for authenticity.

### Optical Watermarks

Subtle Changes in Reflectivity: Creating watermarks that are visible only under specific lighting or through special filters.

### Pattern Recognition

Complex Patterns: Using patterns that are machine-readable but difficult for counterfeiters to replicate exactly.

### Material Properties

Inherent Material Signatures: Specific chemical or optical properties of the material that are hard to duplicate.

Each of these features can be used alone or in combination to create a highly secure MOM 413 that is challenging to counterfeit due to the complexity and interaction of multiple security elements.

Image security features: generating a 3D image using an AI Three Dimensional Generative Pre-trained Transformer (3D-GPT) model 300 by: inputting design parameters and specifications into the AI model; training or fine-tuning the 3D-GPT model 300 on a dataset specific to the optical properties of MOM 413; processing said input through the transformer layers of the 3D-GPT to generate a 3D image with: depth perception; realistic shading and texture based on MOM's 413 optical behavior.

A list of image-based security features that can be integrated into Micro Optical Material (MOM) 413 for enhanced anti-counterfeiting:

### Micro-Images

Micro-Text: Extremely small text or numbers visible only under magnification.

Nano-Images: Even smaller images or patterns requiring electron microscopy to view clearly.

### Holographic Images 2D/3D Holograms: Images that appear to have depth or move when viewed from different angles.

Dot Matrix Holograms: Tiny dots that create images, visible only under specific lighting or angles.

### Kinetic Images

Tilting Images: Images that change or animate when the material is tilted.

Parallax Effects: Multiple image layers giving a 3D effect as the viewing angle changes.

### Color-Shifting Images

Optical Variable Ink: Images that change color depending on the viewing angle.

Chromatic Aberration: Using different colors for different parts of an image, visible only under certain conditions.

### Hidden or Latent Images

Latent Images: Images that are not visible under normal viewing but appear under UV light or at certain angles.

Phase Images: Images that become visible when viewed through a phase plate or under specific lighting.

### Polarized Images

Polarization-Sensitive Images: Images that are only visible or change appearance when viewed through a polarizing filter.

### Optical Watermarks

Subtle Image Watermarks: Variations in reflectivity or transparency that form images, only noticeable under specific conditions.

### Fluorescent Images

UV Fluorescent Images: Images that glow under ultraviolet light, revealing hidden patterns or messages.

IR Fluorescent Images: Images that appear or change under infrared light.

### Moiré Patterns

Moiré Effect Images: Overlapping line patterns that create dynamic images when viewed through a specific overlay.

### Multi-Layered Images

Layered Microstructures: Different images on different layers of MOM 413, only fully visible when all layers align correctly.

### Stereograms 3D Stereoscopic Images: Images that give a 3D effect when viewed with special lenses or from a specific angle.

### Encoded Images

QR Code or Data Matrix: Encoded within the image structure, visible to machines but challenging to duplicate by hand.

Digital Watermarking: Hidden digital signatures within the image for machine verification.

### Lenticular Images

Lenticular Lenses: Creating flip, zoom, or morphing effects in the images as the viewing angle changes.

### Interference Images

Interference Patterns: Images created through the interference of light, sensitive to the exact structure of MOM 413.

These image-based security features leverage the optical properties of MOM 413 to create visually complex and machine-verifiable elements that are extremely difficult for counterfeiters to replicate accurately.

### Forensic Security Features in Micro Optical Material (MOM)

Micro Optical Material (MOM) 413 to enhance its anti-counterfeiting capabilities, ensuring authenticity verifiable at a forensic level admissible in legal contexts. These features include the integration of isotopic markers and plastic taggants extruded directly into the MOM's microstructure during fabrication, providing a robust, tamper-evident layer of security that complements the existing optical and AI-driven authentication mechanisms. These forensic elements are designed to be covert, detectable only through specialized analytical techniques, and resistant to replication, making them suitable for high-security applications such as secure documents, currency, and critical infrastructure authentication.

### Isotopic Markers

Isotopic markers are introduced into MOM 413 by embedding stable, non-radioactive isotopes (e.g., carbon-13, nitrogen-15, or oxygen-18) into the polymer substrate during the extrusion or coating process. These isotopes are incorporated in precise, predetermined ratios, creating a unique isotopic signature that is virtually impossible to replicate without access to specialized equipment and knowledge of the exact isotopic composition. The isotopic markers are integrated into MOM's 413 microstructure, such as within the lenticular lenses or diffraction gratings, at a concentration of 0.01-0.1% by weight to ensure detectability without affecting optical properties (e.g., refractive index of 1.52). Detection requires advanced analytical techniques, such as mass spectrometry or nuclear magnetic resonance (NMR) spectroscopy, which can identify the isotopic ratios with a precision of ±0.001 atomic mass units. This signature serves as a forensic fingerprint, verifiable by law enforcement or forensic laboratories, ensuring the MOM's 413 authenticity and traceability to its manufacturer. The isotopic markers are stable under environmental stressors (e.g., UV exposure, temperature variations from −20° C. to 80° C.) and are resistant to chemical tampering, making them a reliable long-term security feature.

### Plastic Taggants

Plastic taggants are microscopic, chemically distinct particles (10-50 microns in size) extruded into MOM's 413 polymer matrix during fabrication. These taggants are composed of proprietary polymer blends or rare-earth-doped compounds, such as yttrium-based phosphors or fluoropolymers, which exhibit unique spectroscopic signatures under specific excitation conditions (e.g., UV, IR, or X-ray fluorescence). The taggants are distributed in a non-repeating or pseudo-random pattern within MOM's 413 microstructure, aligned with optical elements like lenticular lenses or holographic patterns, to enhance security complexity. Each taggant batch may be encoded with a unique identifier, such as a specific fluorescence wavelength (e.g., 450 nm or 650 nm) or a combination of emission peaks, detectable only through specialized forensic equipment like a spectrofluorometer or scanning electron microscope (SEM) with energy-dispersive X-ray spectroscopy (EDS). The taggants are engineered for durability, maintaining their chemical and optical properties through thermal cycling (up to 200° C. during fabrication) and mechanical stress, ensuring long-term integrity. Their microscopic size and covert integration make unauthorized detection or replication extremely challenging, positioning them as admissible forensic evidence in legal proceedings.

### Integration with MOM and 3DGPT Model 300

The forensic security features are seamlessly integrated with the MOM's optical design and the AI Three Dimensional Generative Pre-trained Transformer (3DGPT) model 300 -generated 3D images. During MOM fabrication, isotopic markers and plastic taggants are embedded using high-precision extrusion techniques, ensuring uniform distribution within the substrate without compromising the optical properties critical for 3D effects (e.g., diffraction, refraction, or parallax shift). 3DGPT model 300, trained on a proprietary dataset, incorporates these forensic features into the secure interphase/pattern module by encoding their spatial distribution as part of the 3D image's metadata. This metadata, accessible only through proprietary decoding algorithms within the Secure Pattern Recognition (SPR) 430 mobile application, maps the isotopic and taggant patterns to specific regions of the MOM, enabling dual-layer authentication: optical verification via micro-text or holograms and forensic verification via isotopic or taggant analysis. AI 3D SPR 430 application, leveraging a smartphone camera with at least 48 MP resolution and auxiliary forensic imaging modes (e.g., UV or IR filters), can interface with external forensic tools to validate these features in real time, ensuring compatibility with secure authentication workflows.

### Authentication and Forensic Validation

The forensic security features are authenticated through a multi-tiered process. AI 3D SPR 430 application initially verifies overt and covert optical features (e.g., micro-text, UV fluorescence) using computer vision and AI-driven pattern recognition, achieving a detection accuracy of 99.9% for features as small as 10.6 microns. For forensic validation, the isotopic markers and plastic taggants are analyzed using laboratory-grade equipment, such as gas chromatography-mass spectrometry (GC-MS) for isotopes or laser-induced breakdown spectroscopy (LIBS) for taggants, which provide legally admissible evidence of authenticity. The non-repeating nature of the taggant patterns and the unique isotopic ratios ensure that even sophisticated counterfeiting attempts fail to replicate the exact chemical and structural composition. The system supports secure data transmission of forensic results via encrypted Wi-Fi (802.11ax) or Bluetooth 5.2, compliant with AES- 256 encryption standards, to authorized forensic databases or law enforcement systems.

### Applications and Advantages

These forensic security features enhance MOM's 413 utility in high-stakes applications, including secure documents, banknotes, critical infrastructure credentials, and product validation, where legal defensibility is paramount. The integration of isotopic markers and plastic taggants provides a layered security approach, combining the visual complexity of AI-generated 3D images with chemical and material-based authentication that is resistant to reverse engineering. The features are compatible with the 3D display stack's customized mobile OS, which supports real-time forensic data processing and interconnectivity via DisplayPort 1.4, HDMI 2.1, or secure cloud platforms (e.g., AWS, GCP). This ensures scalability and adaptability across industries, from medical imaging to government security, while maintaining compliance with international forensic standards, such as ISO/IEC 17025 for laboratory testing. The forensic security features, combined with the MOM's optical and AI-driven capabilities, create a counterfeit-resistant system with unparalleled integrity, suitable for both real-time operational use and rigorous legal scrutiny.

Printing applies the designed artwork and security features to the M.O.M., using high-resolution techniques to ensure precise alignment of interphased elements. Finishing enhances the product with adhesives, security features, die cutting to finished size and shape, and conversion of sheets to roll-fed formats for product integration. Fulfillment packages the order for shipment and delivery.

One skilled in the art will appreciate that variations may be made without departing from the spirit of the invention. For instance, the equipment may be substituted with equivalent machinery offering similar capabilities, or additional security layers like RFID integration could be added in the Finishing stage. The process may incorporate automation for real-time QC, using sensors to monitor pitch alignment during printing. This comprehensive workflow enables scalable production of high-security micro-optical 3D printed materials for diverse applications.

Referring now to FIG. 5, by way of example, and not limitation, there is illustrated an example embodiment of three-dimensional (3D) display stack 500 structure illustrating the layered architecture that integrates AI-generated 3D images with optical components for secure, stereoscopic visualization. The diagram shows a vertical stack of distinct layers (referred to as “blocks” herein), each contributing to light manipulation, color reproduction, pixel control, and anti-counterfeiting features. Starting from the top (user-facing side) and moving downward to the bottom (backlight or base side), the layers are as follows. Each layer's function, composition, and role in the overall system is described in detail below, drawing from the proprietary design that incorporates the AI Three Dimensional Generative Pre-trained Transformer (3DGPT) model 300 for depth map generation and Micro Optical Materials (MOMs) for enhanced security and visual effects. Layer name and position in an exemplary stack 500.

Topmost layer is cover glass 510. This protective layer serves as the outermost barrier, typically made of durable, scratch-resistant glass or polymer material with high optical transparency. It safeguards the underlying components from environmental damage, fingerprints, and physical wear while allowing undistorted transmission of light for clear 3D viewing. In the context of the disclosure cover glass 510, enables stereoscopic visualization by maintaining optical integrity, supporting touch interfaces in devices like tablets, and integrating with security features to prevent tampering without affecting parallax shifts generated by 3DGPT model 300 -derived 3D images.

Below cover glass 510 is preferably OCA (Optically Clear Adhesive) 520. A pre-formed adhesive film that bonds cover glass 510 to the underlying 3D film layer. OCA (Optically Clear Adhesive) 520 preferably ensures uniform adhesion with minimal air gaps, providing high optical clarity (refractive index close to 1.52) to avoid light scattering or distortion. This layer enhances structural stability, reduces reflections, and facilitates the seamless integration of MOM microstructures 530, allowing for consistent depth perception and security pattern embedding. OCA (Optically Clear Adhesive) 520 may be crucial for maintaining the alignment of lenticular lenses in MOM microstructures 530, which manipulate light to create parallax effects in AI-generated 3D content.

Below OCA 520 is preferably 3D lens structure 530. This specialized lens, MOM microstructures 530, incorporates micro optical materials (MOMs) with microstructures such as lenticular lenses (radius of curvature≈0.52) and diffraction gratings in non-repeating patterns. It manipulates incoming light to produce 3D visual effects, including depth perception and parallax shifts, based on AI Three Dimensional Generative Pre-trained Transformer (3DGPT) model 300 monocular depth estimation outputs. The layer may also embed anti-counterfeiting elements like micro-text, nano-text, holograms, UV/IR inks, variations in lenticular line spacing to produce one or more frequency, and encoded data (e.g., serial numbers or timestamps), which are only decodable via the Secure Pattern Recognition (SPR) app 430. It enhances security by making duplication difficult, while supporting applications in virtual reality and secure documents through precise light modulation.

LOCA (Liquid Optically Clear Adhesive) 540 below 3D Film. A UV-curable liquid adhesive applied between the 3D Film and the CF Polarizer, which hardens to form a strong, optically transparent bond. It fills microscopic gaps for bubble-free adhesion, ensuring high clarity and preventing delamination under thermal or mechanical stress. In the system, it bonds the MOM-enhanced 3D film to the color reproduction layers, preserving the fidelity of 3DGPT model 300-generated depth maps by minimizing optical aberrations and supporting the integration of security interphases for tamper-resistant imaging.

CF Polarizer (Color Filter Polarizer) 550 below LOCA. This layer modulates light transmission to improve color accuracy and contrast, aligned with the CF Glass to filter polarized light for vibrant RGB reproduction. It selectively allows light waves in specific orientations, reducing glare and enhancing the visibility of embedded security features under varying lighting conditions. Integrated with the 3DGPT's model 300 3D images, it ensures accurate rendering of depth cues in grayscale maps converted to full-color stereoscopic views, critical for applications like medical imaging where precise color-depth correlation is essential.

CF Glass (Color Filter Glass) 560 below CF Polarizer. A glass substrate coated with red, green, and blue (RGB) sub-pixel pigments in a precise pattern for color filtering. It converts white backlight into colored light, enabling high-fidelity image display. In the invention, this layer interacts with the MOM to layer security patterns over AI-generated 3D content, ensuring that depth maps from proprietary datasets (e.g., Nimslo 3D or synthetic scenes) are rendered with accurate foreground-background separation and anti-counterfeit overlays visible only through proprietary authentication.

TFT Glass (Thin-Film Transistor Glass) 570 below CF Glass. This active-matrix layer consists of a glass substrate with thin-film transistors (TFTs) for pixel-level control, allowing rapid switching to display dynamic 3D images. It manages voltage application to liquid crystals or equivalent elements, facilitating real-time updates from the 3DGPT's model 300 outputs. The layer supports high-resolution rendering of complex scenes, integrating with security modules to embed dynamic encoded data that changes with viewing angle, enhancing resistance to forgery in critical applications like currency or identification documents.

TFT Polarizer (Thin-Film Transistor Polarizer) 580 bottommost layer. Laminated onto the TFT Glass, this polarizer filters light from the backlight source, aligning it for passage through the stack. It enhances display contrast by blocking unpolarized light, working in tandem with the CF Polarizer for cross-polarization effects. In the overall system, it provides the foundational light control necessary for the MOM's microstructures to create parallax and depth, ensuring that 3DGPT model 300-generated 3D images are displayed with high visual fidelity and secure features authenticated via smartphone-based computer vision.

This stacked configuration enables the system to produce secure, high-accuracy 3D displays by combining AI-driven depth estimation with advanced optical engineering. The layers collectively support offline authentication via the SPR app 430, leveraging high-resolution smartphone cameras to detect and validate embedded patterns, while optimizing for efficiency in diverse environments.

Three-dimensional (3D) display stack 500 may be utilized for integrating a Micro Optical Material (MOM) 413 with a 3D image generated by AI Three Dimensional Generative Pre-trained Transformer (3DGPT) model 300, incorporating a Secure Interphase/Pattern Module for authentication. Three-dimensional (3D) display stack 500 structure supports high-fidelity 3D visualization and secure applications, leveraging LLM/LVM AI model proprietary datasets and algorithms.

### Integration and Operation

Three-dimensional (3D) display stack 500 aligns MOM's 413 microstructures with the 3DGPT model 300-generated 3D image of model 300 to produce a cohesive, counterfeit-resistant output. 3DGPT model 300 leverages datasets with known depth relationships (e.g., Key Subject, Foreground, Background) to generate accurate depth maps. The Secure Interphase/Pattern Module 415 embeds non-repeating or pseudo-random patterns, enhancing security. SPR 430 application authenticates these features in real time, using proprietary decoding algorithms to verify micro-text or encoded data, ensuring robust anti-counterfeiting measures.

### Fabrication and Applications

MOM 413 is fabricated using lithography to pattern microstructures, aligned with the 3D image to ensure precise display of security features. Three-dimensional (3D) display stack 500 supports applications in secure documents, content, currency, virtual reality, and autonomous navigation, where high-fidelity 3D visualization and security are critical.

### Applications

3D Reconstruction: AI Three Dimensional Generative Pre-trained Transformer is instrumental in generating 3D models from 2D images, useful in fields like virtual reality, gaming, and digital content creation.

Augmented Reality (AR): By providing depth information, AR applications can overlay virtual objects more realistically onto the real world.

Autonomous Navigation: For autonomous vehicles or drones, real-time depth estimation can enhance obstacle avoidance and path planning.

Visual Effects (VFX) in Film: Depth maps can be used to add depth of field effects, fog, or other post-production enhancements to scenes.

Object Detection and Segmentation: Understanding depth helps in better segmentation of objects in images, improving the accuracy of object detection algorithms.

### Objective

Improved Accuracy: Especially in challenging scenarios like indoor environments, reflective surfaces, multi-object depth 2D images.

Improved Accuracy: Especially in challenging scenarios like surface, subsurface, stratosphere images.

Improved Accuracy: Especially in challenging scenarios like medical, cellular, biological, chemical, molecular, subatomic images.

Real-time Performance: Optimizing for faster processing on various hardware platforms.

Integration with Other AI Models: Combining with object detection or semantic segmentation could lead to more holistic scene understanding.

### Mid-Air Gesture Control for 3D Display Stack Structure

Three-dimensional (3D) display stack 500 structure integrates a sophisticated mid-air gesture control system 10, 206 to enable intuitive, contactless interaction with displayed 3D content thereon three-dimensional (3D) display stack 500, enhancing usability across applications such as medical imaging, virtual reality, and secure document visualization. This system employs an array of high-resolution depth-sensing cameras 704, such as time-of-flight (ToF) or structured light sensors, embedded, for example, within display's 208 frame to capture real-time 3D spatial data of user hand movements. These sensors operate at a minimum resolution of 1280×720 pixels with a depth accuracy of ±1 mm within a 0.5-2-meter range, ensuring precise detection of gestures like pinch-to-zoom, hand rotation, swipes, and pointing performed in mid-air. The gesture recognition system 10, 206 leverages an AI-driven module, integrated with the AI Three Dimensional Generative Pre-trained Transformer (3DGPT) model 300, trained on a proprietary dataset of hand gesture patterns. This module uses a convolutional neural network (CNN) combined with recurrent neural network (RNN) layers to interpret complex hand trajectories and map them to specific display commands, such as zooming, rotating, or panning 3D volumetric data or rasterized media, with a response latency of under 50 ms for real-time interaction.

Gesture recognition system 10, 206 processes depth data through a pipeline that includes preprocessing (noise reduction, background subtraction), feature extraction (hand contour, joint positions, and motion vectors), and classification (mapping gestures to predefined actions). 3DGPT model 300 enhances this gesture process by incorporating monocular depth estimation techniques to refine spatial understanding of hand positions relative to the display, ensuring robust performance in diverse lighting conditions and complex scenes. Gesture recognition system 10, 206 supports a gesture vocabulary including pinch-to-zoom (scaling content by adjusting the distance between thumb and index finger), hand rotation (spinning the hand to rotate 3D models along the X, Y, or Z axes), swipe gestures (for navigating menus or switching datasets), and pointing (for selecting specific regions of interest in volumetric data). This enables seamless manipulation of any 3D volumetric content or rasterized medium, such as medical scans, subsurface imaging, or secure 3D documents, in real time.

Display 208, 500 operates on a customized mobile operating system (OS) 204, optimized for low-latency gesture processing and high-fidelity 3D rendering. OS 204, built on a Linux-based or Android-based kernel, manages system resources, including the integration of the Micro Optical Material (MOM) 413 layer and 3DGPT model 300-generated 3D images, while providing a user-friendly interface for gesture-driven controls. It supports interconnectivity through multiple protocols, including Wi-Fi (802.11ax for high-speed data transfer), Bluetooth 5.2 (for low-latency peripheral connections), DisplayPort 1.4, and HDMI 2.1, enabling seamless integration with external devices such as medical imaging systems, VR headsets, or secure authentication servers. OS 204 also incorporates a secure communication layer with end-to-end encryption (AES-256) to protect sensitive data during remote interactions, such as transmitting 3D volumetric datasets or authenticating security features via the Secure Pattern Recognition (SPR) 430 mobile application.

Hardware 10 configuration includes a high-performance system-on-chip (SoC) with a multi-core CPU 102 (e.g., 8-core ARM Cortex at 2.5 GHz), a dedicated GPU 102 for 3D rendering, and a neural processing unit (NPU) for accelerating AI-driven gesture recognition and depth estimation tasks. Display stack 500, comprising the thin-film transistor (TFT) glass, TFT polarizer, color filter (CF) glass, CF polarizer, MOM layer, and liquid optically clear adhesive (LOCA), is engineered to maintain optical clarity and minimize latency during gesture-driven interactions. MOM 413 layer's lenticular lenses, with a radius of curvature of approximately 0.52 and a refractive index of 1.52, ensure precise light manipulation for parallax effects, complementing the gesture system's ability to dynamically adjust 3D perspectives based on user input. The system supports displays 208 up to 24 inches wide by 36 inches tall, optimized for 4K resolution (3840×2160) to render high-fidelity 3D visuals.

This mid-air gesture control system 10, 206 enhances the display's 208 functionality by enabling intuitive, hygienic, and precise manipulation of complex 3D datasets, making it ideal for applications requiring real-time analysis, such as medical diagnostics (e.g., rotating 3D MRI scans), earth observation (e.g., manipulating subsurface geological models), or secure document authentication (e.g., zooming into micro-text or holograms). The integration of robust interconnectivity options and a customized mobile OS 204 ensures compatibility with diverse hardware ecosystems and secure, scalable deployment across industries.

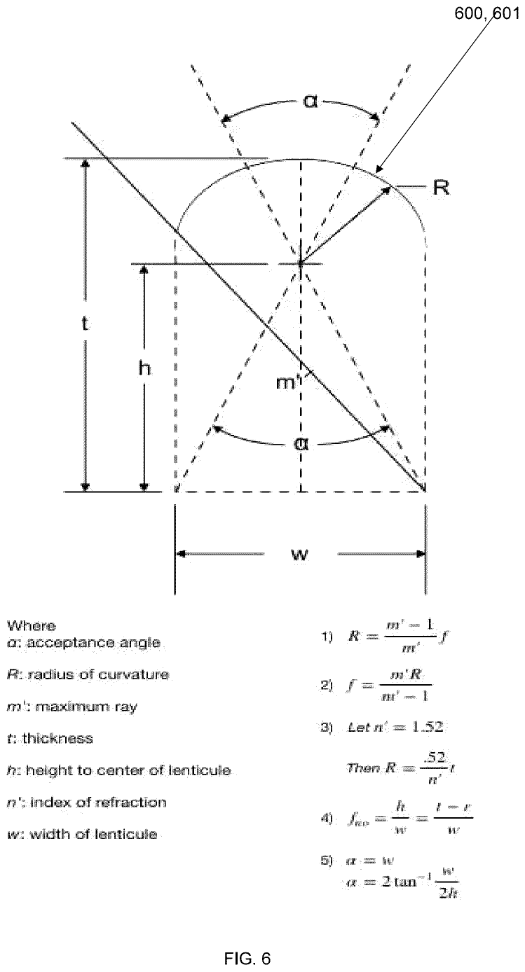

Referring now to FIG. 6, by way of example, and not limitation, there is illustrated an example embodiment of micro-optical materials (M.O.M.) 413, and more particularly to lenticular lens 600 profile designed for use in such materials. Micro-optical materials 413 encompass sheets, films, or substrates incorporating arrays of micro-lenses, such as lenticular arrays, which are employed in applications including, but not limited to, 3D imaging, autostereoscopic displays, directional lighting, optical security features, and high-resolution printing. Lenticular lens 600 profile disclosed herein provides optimized optical performance through specific geometric and material parameters that enhance light directionality, acceptance angle, and focusing efficiency.

FIG. 6 illustrates a cross-sectional view of single lenticule 601 in the lenticular lens array, representing the profile for the micro-optical material 413. The lenticule 601 may be characterized by a convex curved surface interfacing with air and a flat base integrated into the substrate. Light typically propagates through the material from the flat base toward the curved surface, or vice versa, depending on the application. The design ensures that the focal point aligns approximately with the base plane for optimal interleaving of images or light control in M.O.M. 413 applications.

Referring to FIG. 6, the key parameters of lenticule 601 are defined as follows:

α: The acceptance angle, which represents the maximum angular range over which incident light rays can be effectively captured and refracted by lenticule 601 without significant aberration or loss. This angle is critical for determining the viewing zone in lenticular 600 displays or the beam steering capability in optical materials.

R: The radius of curvature of the convex lenticular 601 surface. This parameter governs the refractive power of the lens and is optimized to balance focal length with manufacturability in micro-scale arrays 600.

n′: The index of refraction of lens 601 material. For exemplary purposes, n′=1.52, corresponding to common optical polymers such as polycarbonate, acrylic (PMMA), or similar transparent resins suitable for M.O.M. 413 fabrication via extrusion, embossing, or UV-curing processes. The choice of n′ influences the bending of light rays and allows for tuning the optical properties to specific wavelengths or environmental conditions.

t: The thickness of lenticule 601, measured from the flat base to the apex of the curved surface. This dimension is typically on the order of micrometers to millimeters in M.O.M. 413, depending on the application, and is selected to approximate the focal length for in-plane focusing.

h: The height to the center of lenticule 601, defined as the distance from the flat base to the optical center or principal plane of the lens. This parameter relates to the effective focal positioning and is used in calculating the f-number and acceptance angle.

w: The width of lenticule 601, representing the lateral pitch of lens 601 in the array. In lenticular arrays, w determines the resolution and density of the micro-optics, with smaller w enabling higher-resolution effects but requiring precise manufacturing tolerances.

m′: The maximum ray parameter, which in the context of this profile corresponds to the refractive index n′ for ray tracing purposes. (Note: In some notations, m′ is interchangeably used with n′ for maximum marginal ray calculations in paraxial approximations.)

The relationships among these parameters are governed by the following equations, derived from paraxial optics and adapted for the thick-lens 601 behavior in M.O.M. 413, where lens 601 thickness is comparable to the focal length:

R=\frac{n′−1}{n′} f

This equation expresses the radius of curvature R in terms of the desired focal length f and the refractive index n′. It assumes a plano-convex configuration with the curved surface as the refracting interface, accounting for light propagation within the material of index n′ into air (index 1).

f=\frac{n′ R}{n′−1}

The inverse relation provides the effective focal length f based on R and n′. This formula deviates from the standard thin-lens approximation

f=\frac{R}{n′−1}
to incorporate the effects of the material immersion and thick-lens geometry, ensuring accurate focusing at the base plane in M.O.M. 413 applications.

For a specific material with n′=1.52 (e.g., acrylic), substitute to yield

R=\frac{0.52}{1.52} t \approx 0.342 t
assuming f≈t. This condition positions the focal plane at or near the flat base, ideal for lenticular printing where interleaved images are placed on the rear surface. The factor 0.52 arises from n′−1, and the division by n′ adjusts for the internal refraction.

f_{no}=\frac{h}{w}

The f-number (f_{no}), a measure of the lens's light-gathering ability and depth of field, is defined as the ratio of h to w. In this profile, it characterizes the numerical aperture, with lower values indicating wider acceptance and brighter imaging. Adjustments to h and w allow tailoring the f_{no} for specific M.O.M. 413 uses, such as high-contrast displays or efficient light diffusers.

\alpha=2 \tan\hat{ }{−1} \left(\frac{w}{2h} \right)

The acceptance angle α is calculated using the arctangent function, representing the full angular field from the marginal rays. This equation derives from geometric ray tracing, where the half-width w/2 and height h define the tangent of the half-angle. For small angles, it approximates α≈w/h (in radians), linking directly to the f-number since f_{no}≈h/w≈1/α.

Additionally, the width w may be related to other geometric constraints, such as w=t−r, where r represents a minor adjustment factor (e.g., base offset or sagitta correction) not exceeding a small fraction of t. The sagitta (curved height) can be further approximated as

s \approx \frac{(w/2)\hat{ }2}{2R}
for shallow curves, ensuring the profile remains aspheric-free for ease of replication in M.O. M 413.

In practice, the lenticular array 600 is fabricated by replicating this profile across a substrate, with multiple lenticules arranged in parallel rows or cylindrical fashion. Materials with n′≈1.52 are preferred for their clarity, durability, and compatibility with roll-to-roll processing. The design minimizes crosstalk between adjacent lenticules 601 by optimizing α and w, enhancing the moiré-free performance in 3D visuals.

One skilled in the art will appreciate that variations in n′, t, and w can adapt this profile for diverse M.O.M. 413 applications, such as flexible displays, optical films for solar concentration, or security holograms. For instance, increasing R relative to t widens α for broader viewing angles, while decreasing w boosts array density for finer resolution.

It is contemplated herein that lenticular 601 shape or configuration may be arc, angled, trapezoid or any other configuration, height, and thickness.

It is further contemplated herein that lenticular lens 600 may have varying lenticular 601 spacing, or groups of spacing derived by unique proprietary cylinder 412 to create visually complex, frequency readable, tamper-resistant Micro Optical Materials (MOMs) 413. Such cylinder 412 and its fabrication may be customer specific and held as confidential and proprietary trade secrets.

Referring now to FIGS. 7A and 7B, by way of example, and not limitation, there is illustrated a front view of a single camera device to capture a single RGB image and a flowchart diagram of an exemplary embodiment of steps of an application to confirm or verify authenticity of visually complex, tamper-resistant products and packaging that are difficult to counterfeit, enhancing security for applications like documents, tickets, currency, IDs, virtual reality, stereoscopic displays, and the like.

The present disclosure relates to a secure pattern recognition application 700 for smartphones, designed to accurately detect and analyze printed patterns and complex images while incorporating advanced security measures to prevent duplication or counterfeiting.

In one embodiment, the secure pattern recognition system 700 comprises a mobile application executable on a smartphone device 702, configured to interface with the device's camera 704 for capturing images of printed patterns.

### Smart Phone Access, Optimization, Data Capture

In step or block 710, application 700 may be configured to access and optimize the smartphone's 702 camera 704 and other hardware (see FIGS. 1 and 2). In preferred embodiments, system 700 supports high-resolution cameras 702, such as those with 48 megapixels (MP) or higher, to enable capturing 710 images, data, and the like, such as Security Features. Autofocus and macro mode functionalities are utilized to capture sharp, detailed images at close range. Application 700 includes mechanisms for automatic or manual adjustment of exposure, contrast, and other imaging parameters to adapt to varying lighting conditions, ensuring reliable pattern capture in diverse environments, and the like.

### Image Processing and Analysis

In step or block 720, application 700 may be configured where image processing 720 forms a core component of system. Upon capturing an image, the application applies real-time algorithms including edge detection, noise reduction, and contrast enhancement to preprocess the data. Robust pattern recognition algorithms are integrated to identify and analyze the captured patterns, detecting 720 of small and intricate patterns in image or data with Security Features. In certain embodiments, artificial intelligence (AI) and machine learning models are employed to enhance recognition accuracy. Models 700 may be trained on datasets of various patterns and iteratively improved through adaptive learning as set forth in FIGS. 3 and 4, allowing system 700 to refine its performance over time based on user interactions or accumulated data.

Application 700 processes these images and material, with embedded security features such as micro-text, holograms, lenticular line frequency variations, and encoded data like micro text, more specifically secure pattern 414, interphase file 415, lenticular line frequency variations, and encoded data in Micro Optical Materials (MOMs) 413, as well as QR codes, barcodes, or custom designs (the “Security Features”), while employing security protocols verifying 720 authenticity of Security Features and deterring unauthorized replication. System 700 integrates hardware optimization, software algorithms, and physical security features in the printed patterns to achieve high accuracy and robustness deterance.

### Compatibility and Performance

In step or block 730, application 700 may be configured to ensure broad usability, application 700 may be designed for cross-platform compatibility, supporting both iOS and Android operating systems across a range of device models with varying screen sizes, resolutions, and camera capabilities. Performance optimization is achieved through efficient image and data processing 730 pipelines that minimize computational overhead, thereby reducing battery consumption and preventing device overheating. In offline-capable embodiments, essential data, models, and algorithms are stored locally on the device, enabling pattern recognition without requiring an internet connection.

### Design and User Experience

In step or block 740, application 700 may be configured where user interface (UI) of application 700 is engineered for intuitiveness and ease of use. Clear on-screen 208 instructions guide users in positioning camera 704 relative to pattern, image, or data, such as Security Features. Visual overlays or alignment guides assist in proper framing. Upon successful recognition, system 700 provides feedback through visual indicators on display 208, such as icons or animations, or haptic responses, such as vibrations, to confirm detection. This user-centric design enhances accessibility and reduces errors in pattern capture and verification.

### Security and Privacy Features

In step or block 750, application 700 may be configured where security is integral to system 700 to protect sensitive data and prevent unauthorized access. Captured images, data or pattern data, such as Security Features are encrypted using standard encryption protocols and stored securely on the device or in compliant cloud storage. Application 700 complies with relevant data protection regulations, such as obtaining explicit user consent prior to camera access or data storage. User authentication mechanisms, including biometric verification (e.g., fingerprint or facial recognition) or two-factor authentication, restrict access to sensitive functionalities. Any communications with remote servers or APIs are secured via encryption, such as Transport Layer Security (TLS), to mitigate interception risks.

### Development and Testing Methodologies

In step or block 760, application 700 may be configured to leverage existing software development kits (SDKs) and libraries, such as OpenCV for computer vision tasks, ML Kit for machine learning integration, or Core ML for iOS-specific AI processing, and the like. Platform-native camera APIs, including CameraX for Android and AVFoundation for iOS, are utilized to access advanced hardware features. Rigorous testing protocols are implemented, encompassing device diversity, environmental variations (e.g., lighting and distance), and performance metrics. Continuous integration and deployment (CI/CD) pipelines facilitate automated testing and iterative updates, ensuring compatibility with evolving hardware and software ecosystems.

### Considerations for Dot Size and Resolution in Printed Patterns

The efficacy of the pattern recognition systems in FIGS. 3, 4, and 7 is influenced by the physical characteristics of the image, data, printed patterns, particularly dot size and resolution. Dot size is typically quantified in microns, correlating directly with dots per inch (DPI). For instance, a dot size of 50 microns corresponds to approximately 508 DPI, suitable for high-quality prints that balance detail with visibility. In contrast, a higher resolution of 2400 DPI yields a dot size of about 10.6 microns, enabling intricate patterns but necessitating advanced camera capabilities for detection.

Systems in FIGS. 3, 4, and 7 may be calibrated to match printed dot sizes with the smartphone camera's resolution. High-resolution sensors (e.g., 48 MP) facilitate the recognition of smaller dots, supporting complex, high-DPI patterns. However, this requires high-fidelity printing to maintain consistent dot placement and minimize distortions. Smaller dot sizes enhance recognition accuracy by allowing more detailed patterns, though they impose greater demands on image capture and processing resources. The application is tuned to handle these demands efficiently, preserving overall system performance.

### Security Techniques to Prevent Pattern Duplication

To safeguard against counterfeiting and duplication, the systems in FIGS. 3, 4, and 7 incorporate a suite of advanced security techniques embedded in the printed patterns. These techniques are designed to be difficult to replicate without specialized equipment or knowledge, ensuring the integrity of the recognized patterns.

Microprinting: Involves embedding text or patterns at scales in Micro Optical Materials (MOMs) 413 that are imperceptible to the naked eye, rendering them challenging to reproduce with conventional printers or copiers.

Watermarking: Embeds subtle patterns or images within the substrate Micro Optical Materials (MOMs) 413, visible only under specific conditions such as backlighting, providing a manufacturing-integrated identifier resistant to duplication.

Holograms and Holographic Foils: Utilizes laser-etched 3D images in Micro Optical Materials (MOMs) 413 that alter appearance based on viewing angle, requiring proprietary technology for production.

UV and Infrared (IR) Inks: Employs inks in Micro Optical Materials (MOMs) 413 invisible under standard light but detectable under UV or IR illumination, adding a hidden verification layer.

Anti-Copy Patterns: Designs patterns in Micro Optical Materials (MOMs) 413 that distort or reveal indicators (e.g., “VOID” or “COPY”) upon photocopying or scanning, deterring unauthorized reproduction.

Serial Numbers and QR Codes with Variable Data: Assigns unique identifiers in Micro Optical Materials (MOMs) 413 linked to a centralized database, enabling verification and making mass duplication infeasible.

Secure Substrates: Incorporates materials with embedded elements like threads, fibers, or reflective particles in Micro Optical Materials (MOMs) 413, which are proprietary and hard to replicate.

Digital Watermarking: Integrates imperceptible codes in Micro Optical Materials (MOMs) 413 detectable only by specialized software, facilitating authenticity tracking without visual cues.

Lenticular Printing: Applies lens-based techniques in Micro Optical Materials (MOMs) 413 to create dynamic images with depth or motion effects, complex to counterfeit.

Guilloche Patterns: Features intricate, fine-line designs in Micro Optical Materials (MOMs) 413 generated by specialized algorithms, resistant to replication due to their precision.

Tamper-Evident Seals: Includes seals in Micro Optical Materials (MOMs) 413 that exhibit visible alterations upon tampering, providing physical evidence of interference.

Nano-Text and Nano-Patterns: Utilizes nanotechnology in Micro Optical Materials (MOMs) 413 for patterns at sub-micron scales, nearly impossible to duplicate without advanced facilities.

Color-Shifting Inks: Inks to print on Micro Optical Materials (MOMs) 413 that vary in color based on angle or lighting, unachievable with standard printing methods.

In embodiments, these techniques may be combined selectively based on the application context, such as integrating UV inks with microprinting for enhanced in combination for multi-layer security. The pattern recognition application 700 may be programmed to detect and validate these features during analysis, rejecting patterns that fail authenticity checks.

The embodiments described herein provide a secure, efficient, and user-friendly system for pattern recognition on smartphones. By addressing technical, performance, and security aspects, the invention ensures reliable operation while protecting against duplication threats. Variations, such as custom pattern designs or integration with additional sensors, may be implemented without departing from the inventive principles.

The foregoing description enables the construction and use of the disclosure, with all parameters scalable to micro-optical scales (e.g., w<100 μm) using standard techniques like hot embossing or photolithography.

### AI Module

Systems in FIGS. 3, 4, and 7 utilizing AI may includes data input module 206A, preprocessing module 206B, machine learning model module 206C, inference module 206D, and output module 206E. These modules may be implemented in hardware, software, or a combination thereof, such as on one or more processors executing instructions stored in non-transitory computer-readable media.

Data input module 206A may be configured to receive input data from various sources, including camera 704, sensors, databases, user interfaces, or networked devices. Input data may comprise structured data (e.g., tabular datasets), unstructured data (e.g., text, images, audio signals), or semi-structured data (e.g., JSON files), image files. For example, in a cybersecurity application, input data may include network packets; in a medical context, it may include genetic sequences or patient records.

Preprocessing module 206B processes the input data to prepare it for the machine learning model. Preprocessing steps may include normalization, discretization, feature extraction, and transformation. Discretization, for instance, involves converting continuous variables into discrete bins to facilitate model training, such as using equal-width or equal-frequency binning techniques. In audio or image processing embodiments, preprocessing may involve applying a short-time Fourier transform (STFT) to convert time-domain signals into spectrograms for frequency-domain analysis.

Machine learning model module 206C hosts one or more AI models, such as ANNs, DNNs, convolutional neural networks (CNNs), recurrent neural networks (RNNs), or ensemble models. A generic ANN structure comprises neurons, each including a register for storing values, a microprocessor for computations, and inputs for receiving signals. Synaptic circuits connect neurons, storing synaptic weights in memory elements. The model may be implemented in application-specific integrated circuits (ASICs) for hardware acceleration, providing faster inference compared to software-only implementations.

Training of model 206C involves receiving a training dataset of images, which may include historical data labeled with ground truth outcomes. The training process uses backpropagation to compute gradients of a loss function (e.g., mean squared error or cross-entropy) with respect to the weights, followed by optimization via gradient descent or variants like Adam optimizer. For example, the loss function L may be defined as L=(1/N)Σ(y_i−ŷ_i)\hat{ }2, where y_i is the true label, ŷ_i is the predicted value, and N is the number of samples. Weights are updated iteratively: w_new=w_old−η*∇L, where η is the learning rate and ∇L is the gradient. In embodiments involving embedding-based processing, such as speech separation, the model maps input features to embedding vectors V=f_θ(X), where f_θ is the neural network with parameters θ, and X is the input spectrogram. The objective is to minimize intra-class distances and maximize inter-class distances in the embedding space, often using a contrastive loss function.

For risk scoring applications, such as in personalized medicine, the model computes a polygenic risk score (PRS) from genetic data. This involves identifying alleles at informative single nucleotide polymorphisms (SNPs), weighting them by effect sizes (e.g., via multiplication: weighted_allele=allele_value*effect_size), and summing the weighted values (addition: PRS=Σ weighted_alleles). The model may classify risks by comparing the PRS to reference thresholds, such as quartiles derived from population data.

Inference module 206D applies the trained model 206C to new input data to generate predictions or classifications. In real-time scenarios, such as anomaly detection, the module monitors data streams, identifies deviations (e.g., using threshold-based anomaly scores), and analyzes them for type or cause. For clustering tasks, techniques like k-means may partition embeddings into groups, assigning binary masks (e.g., 1 for target clusters, 0 otherwise) to separate sources. Post-inference processing may include reconstructing outputs, such as applying an inverse STFT to convert masked spectrograms back to time-domain waveforms, followed by stitching methods like overlap-add to form coherent signals.

Output module 206E integrates the AI results into practical actions. Outputs may include visualizations (e.g., dashboards), alerts, or automated controls. In network security embodiments, upon detecting malicious packets, the system may drop the packets, determine the source IP, and block further traffic. In medical embodiments, high-risk classifications may trigger treatment recommendations, such as administering a specific compound. The module may also facilitate retraining by feeding back inference data to update the model, enabling continual learning.

These forensic security features enhance the MOM's 413 utility in high-stakes applications, including secure documents, banknotes, critical infrastructure credentials, and product validation, where legal defensibility is paramount. The integration of isotopic markers and plastic taggants provides a layered security approach, combining the visual complexity of AI-generated 3D images with chemical and material-based authentication that is resistant to reverse engineering. The features are compatible with the 3D display stack's 500 customized mobile OS 208, which supports real-time forensic data processing and interconnectivity via DisplayPort 1.4, HDMI 2.1, or secure cloud platforms (e.g., AWS, GCP). This ensures scalability and adaptability across industries, from medical imaging to government security, while maintaining compliance with international forensic standards, such as ISO/IEC 17025 for laboratory testing. The forensic security features, combined with the MOM's 413 optical and AI-driven capabilities, create a counterfeit-resistant system with unparalleled integrity, suitable for both real-time operational use and rigorous legal scrutiny.

Concerning the description herein, it is to be realized that the optimum dimensional relationships, including variations in size, materials, shape, form, configuration, position, connection, function and manner of operation, assembly and use, are intended to be encompassed by the present disclosure.

It is further understood herein that the parts and elements of this disclosure may be located or positioned elsewhere based on one of ordinary skill in the art without deviating from the present disclosure.

With respect to the above description, it is to be realized that the optimum dimensional relationships, including variations in size, materials, shape, form, position, movement mechanisms, function and manner of operation, assembly and use, are intended to be encompassed by the present disclosure.

The foregoing description and drawings comprise illustrative embodiments. Regarding the described exemplary embodiments, it should be noted by those skilled in the art that the disclosures within are exemplary only, and that various other alternatives, adaptations, and modifications may be made within the scope of the present disclosure. Merely listing or numbering the steps of a method in a particular order does not constitute any limitation on the order of the steps of that method. Many modifications and other embodiments will come to mind for one skilled in the art this disclosure pertains to, having the benefit of the teachings presented in the foregoing descriptions and the associated drawings. Although specific terms may be employed herein, they are used in a generic and descriptive sense only and not for purposes of limitation. Moreover, the present disclosure has been described in detail; it should be understood that various changes, substitutions and alterations can be made thereto without departing from the spirit and scope of the disclosure as defined by the appended claims. Accordingly, the present disclosure is not limited to the specific embodiments illustrated herein but is limited only by the following claims.

1. A secure three-dimensional (3D) imaging system comprising:
a processor and a memory storing instructions executable by said processor;
a Three Dimensional Generative Pre-trained Transformer (3DGPT) model configured to receive a single two-dimensional (2D) RGB image and generate a 3D depth map via monocular depth estimation, wherein said 3DGPT model comprises an encoder-decoder neural network trained on proprietary datasets including paired RGB images and ground truth depth maps with key subject, foreground, and background elements;
a Micro Optical Material (MOM) layer integrated with said generated 3D depth map, said MOM layer comprising lenticular lenses and microstructures configured to produce parallax effects; and
security features embedded in said MOM layer, including at least one of micro-text, holograms, lenticular line frequency variations, or encoded data, configured to resist counterfeiting.

2. The system of claim 1, wherein said proprietary datasets further comprising legacy 3D formats including Nimslo and Nidek medical images, synthetic data, and multi-view disparities for zero-shot cross-dataset transfer.

3. The system of claim 1, wherein said encoder-decoder neural network includes attention mechanisms and multi-scale supervision with reprojection losses for multi-view consistency.

4. The system of claim 1, wherein said 3DGPT model employs optimized loss functions invariant to depth range, scale, and biases, including supervised losses, regularization losses, and photometric losses.

5. The system of claim 1, further comprising a Secure Pattern Recognition (SPR) application executable on a mobile device, configured to authenticate said security features using a high-resolution camera and computer vision algorithms for real-time pattern analysis.

6. The system of claim 5, wherein said SPR application supports offline functionality and is compatible with iOS and Android platforms, optimizing battery efficiency and processing high-resolution captures of at least 48 megapixels.

7. The system of claim 1, wherein said MOM layer has lenticular lenses with a radius of curvature of approximately 0.52 and a refractive index of 1.52, configured to manipulate light for depth perception and non-repeating diffraction gratings.

8. The system of claim 1, further comprising a 3D display stack including:
a thin-film transistor (TFT) glass layer for pixel control;
a color filter (CF) glass layer with RGB sub-pixels;
optically clear adhesives bonding said TFT and CF layers to said MOM layer; and
a protective cover layer for stereoscopic visualization.

9. The system of claim 1, wherein said security features further include nano-text, UV/IR inks, and encoded data such as serial numbers or timestamps, verifiable via proprietary decoding methods.

10. The system of claim 1, wherein said system is configured for applications in secure documents, labels, tickets, currency, virtual reality, augmented reality, medical imaging, earth observation.

11. A method for generating secure 3D images, comprising:
selecting and preparing proprietary datasets comprising paired RGB images and ground truth depth maps with key subject, foreground, and background elements;
training a Three Dimensional Generative Pre-trained Transformer (3DGPT) model on said datasets using an encoder-decoder neural network with optimized loss functions;
receiving a single 2D RGB image and generating a 3D depth map via monocular depth estimation with said trained 3DGPT model;
integrating said 3D depth map with a Micro Optical Material (MOM) layer comprising lenticular lenses and microstructures for parallax effects; and
embedding security features in said MOM layer, including at least one of micro-text, holograms, lenticular line frequency variations, encoded data.

12. The method of claim 11, wherein preparing said datasets includes normalization, augmentation, and extract-transform-load (ETL) processes for structured and unstructured data sources.

13. The method of claim 11, wherein training said 3DGPT model includes multi-objective optimization with supervised, regularization, and photometric losses for scale and bias adaptation.

14. The method of claim 11, further comprising authenticating said security features using a Secure Pattern Recognition (SPR) application on a mobile device, via high-resolution camera capture and AI-driven pattern analysis.

15. The method of claim 11, wherein generating said 3D depth map includes producing grayscale depth maps suitable for 3D mesh generation, generative infill, and parallax shifting.

16. A 3D display stack structure comprising:
a thin-film transistor (TFT) glass layer configured for pixel control;
a TFT polarizer coupled to said TFT glass layer for light filtering;
a color filter (CF) glass layer with RGB sub-pixels, positioned adjacent to said TFT glass layer;
a CF polarizer coupled to said CF glass layer for light modulation;
a Micro Optical Material (MOM) layer comprising lenticular lenses and microstructures for parallax effects and security features;
liquid optically clear adhesive (LOCA) bonding said TFT glass layer and said CF glass layer;
optically clear adhesive (OCA) bonding said MOM layer to a protective cover layer; and
said protective cover layer configured for stereoscopic visualization of AI-generated 3D images integrated with said security features.

17. The structure of claim 16, wherein said MOM layer includes lenticular lenses with a radius of curvature of approximately 0.52, refractive index of 1.52, and non-repeating diffraction gratings.

18. The structure of claim 16, wherein said security features comprise micro-text, nano-text, holograms, UV/IR inks, lenticular line frequency variations, and encoded data embedded in said MOM layer.

19. The structure of claim 16, wherein said AI-generated 3D images are produced by a Three Dimensional Generative Pre-trained Transformer (3DGPT) model trained on proprietary datasets for monocular depth estimation.

20. The structure of claim 16, further configured for compatibility with stereoscopic-enabled tablets or digital displays for applications in augmented reality and anti-counterfeit products.

21. A non-transitory computer-readable medium storing instructions for a Secure Pattern Recognition (SPR) application, said instructions, when executed by a processor of a mobile device, said device to:
capture an image of a secure 3D material using a high-resolution camera;
preprocess said image with edge detection, noise reduction, and contrast enhancement;
analyze said image using computer vision to detect and authenticate security features embedded in a Micro Optical Material (MOM) layer, including at least one of micro-text, holograms, lenticular line frequency variations, or encoded data; and
provide real-time feedback confirming authenticity based on said analysis.

22. The non-transitory computer-readable medium of claim 21, wherein said instructions further cause said device to operate offline, support high-resolution captures of at least 48 megapixels, and comply with data protection regulations for secure image storage and processing.
